(19) United States
(12) Patent Application Publication
(10) Pub. No.: US 2020/0147600 A1
(43) Pub. Date: May 14, 2020

(54) COMPOSITE MATERIAL COMPRISING AN ELECTRIDE COMPOUND

(71) Applicant: BASF SE, Ludwigshafen am Rhein (DE)

(72) Inventors: Stephan A. SCHUNK, Heidelberg (DE); Sebastian SCHAEFER, Heidelberg (DE); Jaroslaw Michael MORMUL, Ludwigshafen am Rhein (DE); Andrei-Nicolae PARVULESCU, Ludwigshafen am Rhein (DE); Grigorios KOLIOS, Ludwigshafen am Rhein (DE); Torsten MATTKE, Ludwigshafen am Rhein (DE); Frank ROSOWSKI, Ludwigshafen am Rhein (DE)

(21) Appl. No.: 16/604,353

(22) PCT Filed: Apr. 11, 2018
(86) PCT No.: PCT/EP2018/059230

§ 371 Date: Oct. 10, 2019

(30) Foreign Application Priority Data
Apr. 11, 2017 (EP) 17166000.4

(51) Int. Cl. B01J 37/34; B01J 37/18; B01J 37/08; B01J 37/00; B01J 35/10; B01J 23/02; B01J 21/04; B01J 21/18; B01J 27/224

(52) U.S. Cl. CPC B01J 37/349; B01J 37/18; B01J 37/08; B01J 37/0081; B01J 35/1009; B01J 27/224; B01J 35/1019; B01J 35/1023; B01J 23/02; B01J 21/04; B01J 21/18; B01J 35/1014

(57) ABSTRACT

A process for preparing a composite material comprising an electride compound and an additive, said process comprising (i) providing a composition comprising the additive and a precursor compound of the electride compound, wherein the precursor compound comprises an oxidic compound of the garnet group, and wherein the additive has a boiling temperature which is higher than the melting temperature of the precursor compound; (ii) heating the composition provided in (i) under plasma forming conditions in a gas atmosphere to a temperature above the Hüttig temperature of the precursor compound and below the boiling temperature of the additive, obtaining the composite material.

The present invention relates to a process for preparing a composite material comprising an electride compound and an additive. Further, the present invention relates to a composite material obtainable or obtained by said process, and further relates to the use of said composite material as a catalyst or a catalyst component. The present invention further relates to a composite material comprising an electride compound, wherein the additive comprises an element of group IIIA or group IVA of the periodic table.

Electride compounds are ionic compounds in which the anions are partially or completely formed by electrons. In particular, in electride compounds, the electrons are not bound to specific atoms or molecules but are located in cavities and/or interspaces of the respective host system, as described, for example, in Y. Nishio et al. In these electride compounds, the electrons act as anions by compensating the positive charge of the framework of the host system. The first electride compounds discovered were alkali metal-ammonia solution containing solvated electrons wherein the characteristic blue color of said solutions serves a proof for the existence of free electrons. In 1983, the first crystalline organic electride Cs⁺(18-crown-6)2(e⁻) was synthesized (J. L. Dye). Subsequently, a whole variety of organic electride compounds was prepared which consisted of alkali metal ions and organic complex forming compounds. These electrides are characterized in that they are stable only under inert conditions at temperatures of up to −40° C. Due to these stability issues, a technical and an industrial use were not possible.

It was an object of the present invention to provide electride compound-based materials which are specifically useful as a catalyst or as a catalyst component. According to the present invention, it was found that this problem can be solved by composite material which, in addition to an electride compound, comprises an additive.

US 2006/0151311 A1 discloses a method for preparing an inorganic electride compound (12CaO7Al₂O₃) comprising treating a suitable precursor compound at certain elevated temperatures for 240 h. The same holding time of 240 h is disclosed in the later published US 2009/0224214 A1. In a subsequent publication, the preparation of an electride compound was disclosed, comprising a heat treatment of a precursor compound in vacuum (10⁻⁴ Pa) at 800° C. for 15 h (US 2015/0217278 A1). For a commercially interesting production of the above mentioned composite materials, there was thus the need to provide a process allowing for much lower synthesis times of said composite materials, preferably for synthesis times of at most or less than 1 h, more preferably of at most or less than 10 min, more preferably of at most or less than 5 min.

According to the present invention, this problem was solved by providing a process wherein a suitable composition comprising a precursor compound of an electride compound and an additive is subjected to a heat treatment under specific heating conditions.

Therefore, the present invention relates to a process for preparing a composite material comprising an electride compound and an additive, said process comprising
(i) providing a composition comprising the additive and a precursor compound of the electride compound, wherein the precursor compound comprises an oxidic compound of the garnet group, and wherein the additive has a boiling temperature which is higher than the melting temperature of the precursor compound;
(ii) heating the composition provided in (i) under plasma forming conditions in a gas atmosphere to a temperature above the Hüttig temperature of the precursor compound and below the boiling temperature of the additive, obtaining the composite material.

The term “composite material” as used herein is a material made from two or more constituent materials, having different physical or chemical properties, which when combined provide a material having characteristics different from the characteristics of the individual constituent materials. According to the present invention, the composite material is characterized by a chemical connection of the individual constituent materials.

The term “heating the composition to a temperature . . . ” as used herein is the time necessary for heating the composition from a starting temperature to said temperature plus the time the composition is kept at this at this temperature.

The Hüttig temperature of the oxidic precursor compound as well-known by the skilled person is the temperature necessary for the surface recrystallization of the oxidic precursor compound, wherein specifically, the Hüttig temperature is 0.26 T_{M}, T_{M} being the absolute melting temperature of the oxidic precursor compound.

Regarding the plasma forming conditions according to (ii), no specific limitations exist, provided that the plasma forming conditions are suitable to generate the above defined temperatures above which the composition is to be heated according to (ii). Preferably, the plasma forming conditions according to (ii) comprise heating the composition in an electric arc, more preferably in an electric arc and a gas atmosphere which is suitable for generating a plasma. The term “plasma” as used herein describes a mixture of particles on an atomic-molecular level the components of which are ions and electrons.

Preferably, according to (ii), heating the composition under plasma forming conditions comprises heating the composition in an electric arc, more preferably comprising
(i) providing a composition comprising the additive and a precursor compound of the electride compound, wherein the precursor compound comprises an oxidic compound of the garnet group, and wherein the additive has a boiling temperature which is higher than the melting point of the precursor compound;
(ii) heating the composition provided in (i) in an electric arc in a gas atmosphere to a temperature above the Hüttig temperature of the precursor compound and below the boiling temperature of the additive, obtaining the electride compound.

Preferably according to (ii), the composition provided in (i) is heated to a temperature above the Tamman temperature of the precursor compound and below the boiling temperature of the additive.

The Tamman temperature of the oxidic precursor compound as well-known by the skilled person is the temperature necessary for the lattice (bulk) recrystallization of the oxidic precursor compound, wherein specifically, the Tamman temperature is 0.52 T_{M}, T_{M} being the absolute melting temperature of the oxidic precursor compound.

More preferably according to (ii), the composition provided in (i) is heated to a temperature above the melting temperature of the precursor compound and below the boiling temperature of the additive.

Using these heating conditions according to (ii), it was found to be possible to significantly reduce the total heating times described in the prior art and, further, the provide a composite material which is suitable as a catalyst or as a catalyst component.

The term “oxidic compound of the garnet group” as used in the context of the present invention, also referred to as “oxidic compound of the garnet mineral group” or “oxidic compound of the garnet supergroup” relates to a compound which comprises oxygen and which is isostructural with garnet regardless of what elements occupy the four atomic sites, wherein the general formula of the garnet supergroup minerals is {X₃}[Y₂]{Z₃}A₁₂, wherein X, Y and Z refer to dodecahedral, octahedral, and tetrahedral sites, respectively, and A is O, OH, or F. Most garnets are cubic, space group Ia-3d, and two OH bearing species have tetragonal symmetry, space group 14₁/acd. Reference is made, for example, to E. S. Grew et al.

Preferably, the oxidic compound of the garnet group according to (i) comprises one or more of calcium and yttrium, more preferably calcium, preferably at the X site. Preferably, the oxidic compound of the garnet group according to (i) comprises aluminum, preferably at Y and/or Z site. Further, the oxidic compound of the garnet group according to (i) may further comprise one or more of magnesium, gallium, silicon, germanium, tin, strontium, titanium, zirconium, chromium, manganese, iron, cobalt, nickel, copper, and zinc.

Preferably at least 90 weight-%, more preferably at least 95 weight-%, more preferably at least 99 weight-%, more preferably at least 99.5 weight-%, more preferably at least 99.9 weight-% of the oxidic compound of the garnet group according to (i) consist of calcium, aluminum, and oxygen.

Preferably, the oxidic compound of the garnet group according to (i) comprises calcium and aluminum at an elemental ratio Ca:Al in the range of from 11.5:14 to 12.5:14, more preferably in the range of from 11.8:14 to 12.2:14, more preferably in the range of from 11.9:14 to 12.1:14, more preferably the oxidic compound of the garnet group according to (i) comprises calcium and aluminum at an elemental ratio Ca:Al of 12:14.

Preferably, the oxidic compound of the garnet group according to (i) comprises calcium and oxygen at an elemental ratio Ca:O in the range of from 11.5:33 to 12.5:33, more preferably in the range of from 11.8:33 to 12.2:33, more preferably in the range of from 11.9:33 to 12.1:33, more preferably the oxidic compound of the garnet group according to (i) comprises calcium and oxygen at an elemental ratio Ca:O of 12:33.

Preferably, the oxidic compound of the garnet group is a crystalline material exhibiting cubic structure and crystallographic space group I-43d. More preferably the oxidic compound of the garnet group comprises, preferably is a mayenite. More preferably, the oxidic compound of the garnet group comprises, preferably is a compound Ca₁₂Al₁₄O₃₃. It is noted that according to the present invention, the mineral mayenite Ca₁₂Al₁₄O₃₃ which has the space group I-43d and a lattice constant of 1198 pm, and further derivatives thereof, is/are defined as being encompassed by the garnet supergroup of minerals and structures mentioned above.

Generally, in the precursor compound, side phases may occur which can be oxides or hydroxides of the single oxides or of a mixed oxide phase. Examples of such side phases include, but are not restricted to, calcium oxide, aluminum oxides like alpha alumina, theta alumina or gamma alumina, mixed calcium aluminum oxides like Ca₃Al₂O₆ (tricalcium aluminate) or CaAl₂O₃ (krotite). Preferably, at least 80 weight-%, more preferably at least 85 weight-%, more preferably at least 90 weight-%, more preferably at least 95 weight-%, more preferably at least 99 weight-% of the precursor compound consist of an oxidic compound of the garnet group.

Preferably, the precursor compound provided according to (i) has a BET specific surface area, determined according to ISO 9277 via physisorption of nitrogen at 77 K, of at least 2 m²/g, more preferably of at least 3 m²/g, more preferably of at least 5 m²/g, more preferably in the range of from 2 to 1000 m²/g, more preferably in the range of from 3 to 1000 m²/g, more preferably in the range of from 5 to 1000 m²/g, more preferably in the range of from 5 to 500 m²/g, more preferably in the range of from 5 to 100 m²/g.

Generally, the precursor compound provided according to (i) can be in the form of a powder having a particle size in the sub-micrometer range. Preferably, the precursor compound provided according to (i) is in the form of particles having a mean particle size, determined according to Reference Example 1.7, in the range of from 1 to 2000 micrometer, more preferably in the range of from 10 to 500 micrometer, more preferably in the range of from 20 to 200 micrometer.

The additive may comprise a metal compound, a semi-metal compound or a non-metal compound.

Preferably the additive provided according to (i) has a boiling temperature which is at least 20° C., more preferably at least 50° C., more preferably at least 100° C., more preferably at least 150° C., more preferably at least 200° C. higher than the melting temperature of the precursor compound. Therefore, the additive provided according to (i) may have a boiling temperature which is from 20 to 400° C. or from 50 to 350° C. or from 100 to 300° C. or from 150 to 275° C. or from 200 to 225° C. higher than the melting temperature of the precursor compound.

Preferably, the additive which is most preferably a solid additive comprises a metal compound, a semi-metal compound or a non-metal compound which is an oxygen getter material reducing the oxygen partial pressure during heating under plasma conditions according to (ii).

Preferably, the additive comprises an element of group IIIA or group IVA of the periodic table. More preferably, the additive comprises one or more of aluminum, calcium, titanium, zirconium, tungsten, niobium, tantalum, carbon, and silicon, more preferably comprises, more preferably is one or more of aluminum, graphite, alpha silicon carbide (alpha SiC) and beta silicon carbide (beta SiC).

Preferably, the additive comprises micropores, or mesopores, or macropores, or micropores and mesopores, or micropores and macropores, or mesopores and macropores, or micropores and mesopores and macropores, more preferably mesopores and macropores, more preferably macropores, wherein a micropore has a diameter of less than 2 nm, a mesopore has a diameter in the range of from 2 to 50 nm, and a macropore has a diameter of more than 50 nm.

Preferably, the additive has a BET specific surface area, as determined according to ISO 9277 by nitrogen physisorption at 77 K, in the range of from 2 to 1000 m²/g, more preferably in the range of from 3 to 1000 m²/g, more preferably in the range of from 5 to 1000 m²/g. Preferred ranges include, for example, the range of from 5 to 500 m²/g, or the range of from 3 to 500 m²/g, or the range of from 5 to 100 m²/g.

Generally, the additive provided according to (i) can be in the form of a powder having a particle size in the sub-micrometer range. Preferably, the additive is in the form of particles, having a mean particle size, determined as described in Reference Example 1.7, in the range of from 1 to 100 micrometer, more preferably in the range of from 3 to 50 micrometer, more preferably in the range of from 5 to 30 micrometer.

Further preferably the additive provided in (i) is in the form of a molding. The geometry of the molding is not subject to any specific restrictions. Preferably, the molding is one or more of a flake, a sphere, a tablet, a star, a strand, a brick optionally having one or more channels with an open inlet end and an open outlet end, an optionally hollow cylinder, and a porous foam.

According to a preferred embodiment of the present invention, the additive comprises, preferably is a molding, and the molding preferably comprises, more preferably consists of silicon carbide, preferably alpha silicon carbide (alpha SiC) and beta silicon carbide (beta SiC), more preferably beta silicon carbide (beta SiC).

Preferably, providing the composition according to (i) comprises
(i.1) providing the precursor compound and providing the additive;
(i.2) preparing the composition comprising the additive and the precursor compound provided in (i.1).

Generally, the precursor compound can be provided by any suitable method. If suitable, a commercially available precursor compound can be used. Preferably, providing the precursor compound according to (i.1.1) comprises
(i.1.1) preparing a mixture comprising a source of calcium, a source of aluminum, and water;
(i.1.2) optionally subjecting the mixture prepared in (i.1.1) to a hydrothermal treatment;
(i.1.3) calcining the mixture prepared in (i.1.1), optionally the mixture obtained from (i.1.2), obtaining the precursor compound.

The source of calcium in (i.1.1) preferably comprises, more preferably is one or more of a calcium oxide, a calcium hydroxide, a hydrated calcium oxide, and a calcium carbonate. More preferably the source of calcium is a calcium oxide, more preferably CaO. More preferably, the source of calcium is highly pure and comprises, in addition to calcium, oxygen and optionally hydrogen, other elements such as sodium, potassium, halides like chlorine or sulfur in respective amounts preferably of at most 0.1 weight-%, more preferably of at most 0.01 weight-%, more preferably of at most 0.001 weight-%, based on the total weight of the source of calcium. Preferred ranges are, for example, 0.000001 to 0.1 weight-% or from 0.00001 to 0.01 weight-% or from 0.0001 to 0.001 weight-%.

The source of aluminum in (i.1.1) is preferably one or more of an aluminum hydroxide including one or more of gibbsite, hydrargillite, bayerite, doyleite, nordstrandite, and gel-like amorphous aluminum hydroxide, an aluminum oxyhydroxide (AlO(OH)) including one or more of pseudo-boehmite, boehmite, diaspor, and akdalaite, and an aluminum oxide including one or more of gamma aluminum oxide, chi aluminum oxide, delta aluminum oxide, eta aluminum oxide, rho aluminum oxide and kappa aluminum oxide. More preferably, the source of aluminum is one or more of gamma alumina, gamma aluminum oxyhydroxide (boehmite) and a pseudo boehmite, more preferably gamma aluminum oxyhydroxide. More preferably, the source of aluminum is highly pure and comprises, in addition to aluminum, oxygen and optionally hydrogen, other elements such as sodium, potassium, halides like chlorine or sulfur in respective amounts preferably of at most 0.1 weight-%, more preferably of at most 0.01 weight-%, more preferably of at most 0.001 weight-%, based on the total weight of the source of calcium. Preferred ranges are, for example, 0.000001 to 0.1 weight-% or from 0.00001 to 0.01 weight-% or from 0.0001 to 0.001 weight-%. Examples of such sources of aluminum are aluminum hydroxides or aluminum oxides which are obtained by the ALFOL process and which are commercially available as high purity aluminum oxides (“hochreine Tonerden”) by vendors like SASOL.

Preferably, the source of aluminum has BET specific surface area determined according to ISO 9277 via physisorption of nitrogen at 77 K, in the range of from 10 to 500 m²/g, more preferably in the range of 50 to 300 m²/g, more preferably in the range of from 100 to 250 m²/g.

Preferably, in the mixture prepared in (i.1.1), the molar ratio of the source of calcium relative to the source of aluminum, preferably the molar ratio of the calcium oxide relative to the gamma aluminum oxyhydroxide, is in the range of from 11.90:14 to 12.10:14, more preferably in the range of from 11.95 to 12.05:14, more preferably in the range of from 11.99:14 to 12.01:4. More preferably, the molar ratio of the source of calcium relative to the source of aluminum, preferably the molar ratio of the calcium oxide relative to the gamma aluminum oxyhydroxide, is 12.00:14.00.

Preferably, the molar ratio of the water relative to the source of aluminum, preferably the gamma aluminum oxyhydroxide, preferably the gamma aluminum oxyhydroxide, calculated as elemental aluminum, is in the range of from 0.1:1 to 50:1, more preferably in the range of from 0.2:1 to 30:1, more preferably in the range of from 0.3:1 to 20:1, more preferably in the range of from 0.5:1 to 10:1. Preferred ranges are, for example, from 0.5:1 to 2:1 or from 2:1 to 4:1 of from 4:1 to 6:1 or from 6:1 to 8:1 or from 8:1 to 10:1.

The mixture prepared according to (i.1.1) can be carried out according any suitable method known by the skilled person. Preferably, preparing the mixture according to (i.1.1) comprises agitating the mixture, more preferably mechanically agitating the mixture. More preferably, mechanically agitating the mixture comprises milling or kneading the mixture, more preferably milling the mixture.

For the calcining according to (i.1.3), the mixture is preferably calcined in a gas atmosphere, wherein the gas atmosphere comprises oxygen, wherein more preferably, the gas atmosphere is oxygen, air, lean air, or synthetic air. Preferably, the gas atmosphere is a gas stream and the mixture is calcined at a flow rate of the gas stream in the range of from 1 to 10 L/min, more preferably in the range of from 3 to 9 L/min, more preferably in the range of from 5 to 8 L/min. Preferably, the gas atmosphere has a temperature in the range of from 400 to 1400° C., more preferably in the range of from 500 to 1350° C., more preferably in the range of from 600 to 1300° C., more preferably in the range of from 700 to 1300° C., more preferably in the range of from 750 to 1250° C. Preferably, the mixture is heated to the temperature at a heating rate in the range of from 1 to 8 K/min, more preferably in the range of from 2 to 7 K/min, more preferably in the range of from 3 to 6 K/min.

According to one embodiment of the process of the present invention, a hydrothermal treatment is carried out according to (i.1.2).

Preferably, according to (i.1.2), the mixture is heated under autogenous pressure, more preferably in an autoclave, to a temperature in the range of from 35 to 250° C., more preferably in the range of from 40 to 200° C., more preferably in the range of from 50 to 100° C., more preferably in the range of from 50 to 150° C. Preferably, the mixture is kept at this temperature for a period of time of at most 90 h, more preferably at most 70 h, more preferably at most 50 h. More preferably, the mixture is kept at this temperature for a period of time in the range of from 1 to 90 h, more preferably in the range of from 3 to 70 h, more preferably in the range of from 6 to 50 h.

Preferably, (i.1.2) further comprises drying the mixture obtained from the hydrothermal treatment, preferably in a gas atmosphere, wherein the gas atmosphere more preferably comprises oxygen, wherein more preferably, the gas atmosphere is oxygen, air, lean air, or synthetic air, and wherein the gas atmosphere has a temperature preferably in the range of from 40 to 150° C., more preferably in the range of from 50 to 120° C., more preferably in the range of from 60 to 100° C. Prior to drying, the mixture obtained from the hydrothermal treatment can be subjected to filtration optionally followed by washing.

Preferably, in the mixture prepared in (i.1.1), the molar ratio of the water relative to the source of aluminum, preferably the gamma aluminum oxyhydroxide, calculated as elemental aluminum, is preferably in the range of from 0.1:1 to 50:1, preferably in the range of from 0.2:1 to 30:1, more preferably in the range of from 0.3:1 to 20:1, more preferably in the range of from 0.5:1 to 10:1. Further, if the hydrothermal treatment according to (i.1.2) is carried out, according to (i.1.3), the mixture is calcined in a gas atmosphere, wherein the gas atmosphere comprises nitrogen and/or oxygen, wherein more preferably, the gas atmosphere is oxygen, air, lean air, or synthetic air. The gas atmosphere preferably has a temperature in the range of from 400 to 1400° C., more preferably in the range of from 400 to 1200° C., more preferably in the range of from 400 to 1000° C., more preferably in the range of from 400 to 800° C.

Preferably, preparing the composition according to (i.2) comprises mixing the additive with the precursor compound. Blending is carried out so that the additive and the precursor compound, e.g. the mayenite material, get in intimate contact to allow for physical interaction and chemical reaction during the plasma treatment step. Preferably, for mixing the additive with the precursor compound, an adjuvant is employed enhancing the adhesion between additive and the precursor compound. Preferably, the adjuvant comprises one or more of water, glycerol, an alkane, an aqueous methyl cellulose solution, an ethylene glycol, a polyethylene glycol, a polypropylene glycol, a polyvinyl pyrrolidone, and a polyvinyl alcohol. Preferably, mixing the additive with the precursor compound comprises mixing in a tumbler blender, a convective blender, or a fluidization blender.

Preferably, preparing the composition according to (i.2) further comprises compacting the composition obtained from mixing. Such compacting can be carried out by any suitable means known by the skilled person. Such suitable means include, for example, pressing to a predefined form, for example tableting, extruding and the like. Preferably, preparing the composition according to (i.2) further comprises extruding the composition obtained from mixing.

The composition provided in (i) is preferably in the form of a molding. The geometry of the molding provided in (i) is not subject to any specific restrictions. Preferably, the molding is one or more of a flake, a sphere, a tablet, a star, a strand, a brick optionally having one or more channels with an open inlet end and an open outlet end, an optionally hollow cylinder, and a porous foam. Preferably, the molding is in the form of a tablet, in the form of a porous foam, or a sphere.

Preferably at least 90 weight-%, more preferably at least 95 weight-%, more preferably at least 98 weight-% of the composition provided in (i) consist of the additive, the precursor compound and optionally an adjuvant as defined for the composition. Preferably, in the composition provided in (i), the weight ratio of the precursor compound relative to the additive is in the range of from 0.01:1 to 1000:1, preferably in the range of from 0.1:1 to 500:1, more preferably in the range of from 1:1 to 90:1.

According to (ii), the composition provided in (i) is heated under plasma-forming conditions.

Heating under plasma forming conditions can be carried out in continuous mode. In order to process the composition continuously several modes of operation are feasible. According to a first method, a plasma torch can be moved over a static bed comprising the composition under conditions suitable to form an electride compound wherein the movement of the torch can be circular or unidirectional. According to a second method, a bed comprising the composition is moved under a static plasma torch under conditions suitable to form an electride compound wherein the movement of the composition can be circular or unidirectional. According to a third method, a continuous stream comprising the composition preferably having a defined particle size is fed through a plasma torch. This can either be achieved by feeding the composition in the form of a powder through a plasma torch or passing the composition in the form of an aerosol through a plasma torch. In this case, the powder may preferably have a mean particle size in range of from 0.1 to 2000 micrometer, more preferably in the range of from 0.5 to 1000 micrometer, more preferably in the range of from 0.7 to 500 micrometer. Generally, a suitable gas can be fed co-current or counter-current with the composition through the plasma torch. Preferred conditions suitable to form an electride compound are described herein below.

Preferably, according to the present invention the, heating according to (ii) is carried out in a batch process using an electric arc furnace which comprises a first electrode and a second electrode between which the electric arc is formed, wherein on the second electrode, the composition provided in (i) to be heated is positioned, and wherein during heating according to (ii), the electrical power of the light arc between the first electrode and the second electrode is in the range of from 100 to 4000 W, more preferably in the range of from 500 to 3000 W, more preferably in the range of from 750 to 2000 W. Preferred ranges include, for example, from 750 to 1250 W or from 1000 to 1500 W or from 1250 to 1750 W or from 1500 to 2000 W. Depending on the scale, the electrical power of the light arc between the first electrode and the second electrode may range in the range of from 100 to 4,000,000 W (Watt), more preferably in the range of from 500 to 300,000 W, more preferably in the range of from 750 to 100,000 W.

Preferably, the electric arc furnace further comprises a gas-tight housing enclosing the first electrode and the second electrode, and further enclosing the gas atmosphere according to (ii). More preferably, the first electrode is positioned vertically above the second electrode, and the gas-tight housing comprises means for at least partially removing a gas atmosphere from the housing and for feeding a gas atmosphere into the housing.

The first electrode preferably comprises tungsten, a mixture of tungsten with zirconium oxide, a mixture of tungsten with thorium oxide, a mixture of tungsten with lanthanum oxide, or a mixture of tungsten with copper, preferably comprises tungsten, more preferably is a tungsten electrode.

If zirconium oxide is comprised in addition to tungsten, it may be preferred that the electrode comprises from 0.15 to 0.9 weight-% zirconium oxide. If thorium oxide is comprised in addition to tungsten, it may be preferred that the electrode comprises from 0.35 to 4.2 weight-% thorium oxide. If lanthanum oxide is comprised in addition to tungsten, it may be preferred that the electrode comprises from 0.8 to 2.2 weight-% lanthanum oxide. If copper is comprised in addition to tungsten, it may be preferred that the electrode comprises from 10 to 50 weight-% cooper. It is further conceivable that the first electrode comprises tantalum, niobium, molybdenum, carbon, borides such as lanthanum hexaboride, calcium hexaboride, cerium hexaboride, carbides such as tungsten carbide, or titanium carbide. Preferably, the first electrode is the cathode.

The second electrode preferably comprises one or more of metals selected from the group consisting of tungsten, copper, niobium, molybdenum, tantalum, and chromium, preferably comprises copper, more preferably is a copper electrode. If two or more metals are comprised in the second electrode, the electrode may contain an alloy of two or more of these metals. Preferably, the second electrode is the anode.

Preferably, according to (ii), the composition provided in (i) is heated under plasma forming conditions for a period of time in the range of from 1 to 350 s, more preferably in the range of from 2 to 90 s, more preferably in the range of from 5 to 75 s.

Preferably during heating the composition provided in (i) under plasma forming conditions according to (ii), the gas atmosphere has a pressure of less than 1 bar(abs), more preferably in the range of from 0.3 to 0.9 bar(abs), more preferably in the range of from 0.6 to 0.8 bar(abs). According to a further embodiment the gas atmosphere has a pressure more than 1 bar(abs), more preferably in the range of from 1 to 30 bar(abs), more preferably in the range of from 2 to 10 bar(abs). According to a further embodiment, the gas atmosphere preferably has a pressure in the range of from 0.3 to 30 bar(abs), more preferably in the range of from 0.6 to 10 bar (abs).

At the beginning of the heating according to (ii), the temperature of the gas atmosphere is preferably in the range of from 10 to 50° C., more preferably in the range of from 15 to 40° C., more preferably in the range of from 20 to 30° C.

Preferably, heating the composition provided in (i) under plasma forming conditions according to (ii) is carried out under oxygen (O₂) removal conditions. It is preferred that the oxygen removal conditions comprise physical oxygen removal conditions and/or chemical oxygen removal conditions. Preferably, the chemical oxygen removal conditions comprise a gas atmosphere according to (ii) which comprises an oxygen reducing gas. Preferably, the oxygen reducing gas comprises one or more of nitrogen (N₂), methane and hydrogen (H₂), preferably comprises, more preferably consists of hydrogen. Preferably, at least 0.5 volume-%, more preferably at least 5 volume-%, more preferably at least 50 volume-%, more preferably at least 80 volume-%, more preferably at least 90 volume-% of the gas atmosphere consist of hydrogen.

The gas atmosphere according to (ii) preferably comprises a gas which is ionizable under the plasma forming conditions according to (ii). Preferably, the gas which is ionizable under the plasma forming conditions comprises one or more noble gases, more preferably one or more of helium, neon, argon, krypton, xenon, more preferably one or more of helium, neon and argon, wherein more preferably, the gas which is ionizable under the plasma forming conditions comprises argon. Preferably at least 99 volume-%, more preferably at least 99.5 volume-%, more preferably at least 99.9 volume-% of the gas which is ionizable under the plasma forming conditions consist of argon.

Preferably, the gas atmosphere according to (ii) preferably comprises an oxygen reducing gas and a gas which is ionizable under the plasma forming conditions, wherein at the beginning of the heating according to (ii) in the gas atmosphere, the volume ratio of the oxygen reducing gas relative to the gas which is ionizable under the plasma forming conditions is in the range of from 1:99 to 10:90, more preferably in the volumetric range of from 2:98 to 8:92, more preferably in the range of from 4:96 to 6:94. Preferably, at the beginning of the heating according to (ii), at least 99 volume-%, more preferably at least 99.5 volume-%, more preferably at least 99.9 volume-% of the gas atmosphere consist of the oxygen reducing gas and the gas which is ionizable under the plasma forming conditions.

There are no specific restrictions how the optional physical oxygen removal conditions are carried out. The physical oxygen removal conditions preferably comprise
(ii.1) heating the composition provided in (i) in the gas atmosphere under plasma forming conditions for a period of time delta₁t, wherein the gas atmosphere comprises a gas which is ionizable under the plasma forming;
(ii.2) at least partially removing the gas atmosphere after the period of time delta₁t and providing a fresh gas atmosphere comprising a gas which is ionizable under the plasma forming conditions;
(ii.3) further heating of the composition obtained from (ii.2) in the fresh gas atmosphere under plasma forming conditions for a period of time delta₂t.

If physical oxygen removal conditions are realized, the gas atmosphere according to (ii.1) preferably comprises a gas which is ionizable under the plasma forming conditions according to (ii.1). Preferably, the gas which is ionizable under the plasma forming conditions according to (ii.1) comprises one or more noble gases, preferably one or more of helium, neon, argon, krypton, xenon, more preferably one or more of helium, neon and argon, wherein more preferably, the gas which is ionizable under the plasma forming conditions comprises argon. Preferably, at least 99 volume-%, more preferably at least 99.5 volume-%, more preferably at least 99.9 volume-% of the gas which is ionizable under the plasma forming conditions according to (ii.1) consist of argon. The gas atmosphere according to (ii.1) preferably further comprises an oxygen reducing gas which preferably comprises one or more of nitrogen (N₂) and hydrogen (H₂), more preferably comprises, more preferably consists of hydrogen. Preferably, at the beginning of the heating in the gas atmosphere according to (ii.1), the volume ratio of the oxygen reducing gas relative to the gas which is ionizable under plasma forming conditions according to (ii.1) is in the range of from 1:99 to 10:90, more preferably in the range of from 2:98 to 8:92, more preferably in the range of from 4:96 to 6:94. Preferably, at the beginning of the heating in the gas atmosphere according to (ii.1), the volume ratio of the oxygen reducing gas relative to the gas which is ionizable under plasma forming conditions according to (ii.1) is in the range of from 0:100 to 1:99, more preferably in the range of from 0:100 to 0.5:99.5, more preferably in the range of from 0:100 to 0.1:99.9.

At the beginning of the heating according to (ii.1), preferably at least 99 volume-%, more preferably at least 99.5 weight-%, more preferably at least 99.9 weight-% of the gas atmosphere consist of the gas which is ionizable under the plasma forming conditions and optionally the oxygen reducing gas. At the beginning of the heating according to (ii.1), the temperature of the gas atmosphere is in the range of from 10 to 50° C., preferably in the range of from 15 to 40° C., more preferably in the range of from 20 to 30° C.

If physical oxygen removal conditions are realized, the gas atmosphere according to (ii.3) preferably comprises a gas which is ionizable under the plasma forming conditions according to (ii.3). Preferably, he gas which is ionizable under the plasma forming conditions according to (ii.3) preferably comprises one or more noble gases, preferably one or more of helium, neon, argon, krypton, xenon, more preferably one or more of helium, neon and argon, wherein more preferably, the gas which is ionizable under the plasma forming conditions comprises argon. Preferably, at least 99 volume-%, more preferably at least 99.5 volume-%, more preferably at least 99.9 volume-% of the gas which is ionizable under the plasma forming conditions according to (ii.3) consist of argon. Preferably, the gas atmosphere according to (ii.3) further comprises an oxygen reducing gas which preferably comprises one or more of nitrogen (N₂) and hydrogen (H₂), more preferably comprises, more preferably consists of hydrogen. Preferably, at the beginning of the heating in the gas atmosphere according to (ii.3), the volume ratio of the oxygen reducing gas relative to the gas which is ionizable under plasma forming conditions according to (ii.3) is in the range of from 1:99 to 10:90, more preferably in the range of from 2:98 to 8:92, more preferably in the range of from 4:96 to 6:94.

Preferably, at the beginning of the heating in the gas atmosphere according to (ii.1), the volume ratio of the oxygen reducing gas relative to the gas which is ionizable under plasma forming conditions according to (ii.3) is in the range of from 0:100 to 1:99, more preferably in the range of from 0:100 to 0.5:99.5, more preferably in the range of from 0:100 to 0.1:99.9. Preferably, at the beginning of the heating according to (ii.3), at least 99 volume-%, preferably at least 99.5 weight-%, more preferably at least 99.9 weight-% of the gas atmosphere consist of the gas which is ionizable under the plasma forming conditions and optionally the oxygen reducing gas.

At the beginning of the heating according to (ii.3), preferably the temperature of the gas atmosphere is in the range of from 10 to 50° C., more preferably in the range of from 15 to 40° C., more preferably in the range of from 20 to 30° C.

Preferably, the sum of delta₁t and delta₂t, (delta₁t+delta₂t) according to (ii.1) and (ii.3) is in the range of from 1 to 350 s, more preferably in the range of from 2 to 90 s, more preferably in the range of from 5 to 75 s.

After (ii.3), removing the gas atmosphere, providing a fresh gas atmosphere and further heating the composition in the fresh gas atmosphere is repeated at least once, wherein the total heating time according to (ii) is preferably in the range of from 1 to 350 s, more preferably in the range of from 2 to 90 s, more preferably in the range of from 5 to 75 s. For example, after (ii.3), the sequence (a) removing the gas atmosphere and providing a fresh gas atmosphere and (b) further heating the composition in the fresh gas atmosphere can be repeated once, twice, three times, four times, five times, six times, seven times, eight times, nine times, ten times.

After the last heating under plasma conditions, the composite material obtained from (ii) is preferably cooled, and the process of the present invention preferably further comprises (iii) cooling the composite material obtained from (ii).

preferably to a temperature in the range of from 10 to 50° C.

Further, the present invention relates to a composite material comprising an electride compound and an additive, obtainable or obtained or preparable or prepared by a process as described above, comprising steps (i) and (ii), preferably steps (i), (ii), and (iii).

Furthermore, the present invention relates to a composite material comprising an electride compound and an additive, wherein the additive comprises an element of group IIIA or group IVA of the periodic table. Preferably, the composite material comprising an electride compound and an additive, is obtainable or obtained or preparable or prepared by the inventive process. Preferably, the additive comprises one or more of aluminum, carbon, and silicon, more preferably comprises, more preferably is one or more of aluminum, graphite, alpha silicon carbide (alpha SiC) and beta silicon carbide (beta SiC). Preferably, in the composite material, the additive and the electride compound are chemically connected.

Preferably, the electride compound is obtainable or obtained from an oxidic compound of the garnet group by heating a composition comprising and additive and a precursor compound which comprises the oxidic compound of the garnet group under plasma forming conditions as defined in the above process for heating according to (ii). Preferably, the oxidic compound of the garnet group comprises aluminum and/or calcium. Preferably, the oxidic compound of the garnet group comprises one or more of magnesium, gallium, silicon, germanium, tin, strontium, titanium, zirconium, chromium, manganese, iron, cobalt, nickel, copper, and zinc. Preferably, at least 90 weight-%, more preferably at least 95 weight-%, more preferably at least 99 weight-%, more preferably at least 99.5 weight-%, more preferably at least 99.9 weight-% of the oxidic compound of the garnet group consist of calcium, aluminum, and oxygen. Preferably, the oxidic compound of the garnet group comprises calcium and aluminum at an elemental ratio Ca:Al in the range of from 11.5:14 to 12.5:14, more preferably in the range of from 11.8:14 to 12.2:14, more preferably in the range of from 11.9:14 to 12.1:14, more preferably at an elemental ratio Ca:Al of 12:14.

Preferably, the oxidic compound of the garnet group comprises calcium and oxygen at an elemental ratio Ca:O in the range of from 11.5:33 to 12.5:33, more preferably in the range of from 11.8:33 to 12.2:33, more preferably in the range of from 11.9:33 to 12.1:33, more preferably comprising calcium and oxygen at an elemental ratio Ca:O 12:33. Preferably, the oxidic compound of the garnet group is a crystalline material exhibiting cubic structure and crystallographic space group I-43d. More preferably, the oxidic compound of the garnet group comprises, preferably is a mayenite. More preferably, the oxidic compound of the garnet group comprises, preferably is a compound Ca₁₂Al₁₄O₃₃. Preferably, in the oxidic compound, side phases may occur which can be oxides or hydroxides of the single oxides or of a mixed oxide phase. Exampies of such side phases include, but are not restricted to, calcium oxide, aluminum oxides like alpha alumina, theta alumina or gamma alumina, mixed calcium aluminum oxides like Ca₃Al₂O₆ (tricalcium aluminate) or CaAl₂O₃ (krotite).

Preferably, the composite material is a porous composition and having micropores, or mesopores, or macropores, or micropores and mesopores, or micropores and macropores, or mesopores and macropores, or micropores and mesopores and macropores, more preferably having mesopores and macropores, more preferably having macropores, wherein a micropore has a diameter of less than 2 nm, a mesopore has a diameter in the range of from 2 to 50 nm, and a macropore has a diameter of more than 50 nm.

The composite material preferably has a BET specific surface area of at least 2 m²/g, more preferably of at least 3 m²/g, more preferably of at least 5 m²/g, more preferably having a BET specific surface area in the range of from 2 to 1000 m²/g, more preferably having a BET specific surface area in the range of from 3 to 500 m²/g, more preferably in the range of from 5 to 250 m²/g.

Preferably, in the composite material, the weight ratio of the electride compound relative to the additive is in the range of from 0.01:1 to 15:1, more preferably in the range of from 0.1:1 to 500:1, more preferably in the range of from 1:1 to 90:1.

Further, the composite material comprising an electride compound and an additive may also include one or more further, such as one or more components comprised in the precursor compound of the electride compound which is inert or essentially inert during heating under the plasma forming conditions, and/or one or more components which are formed during heating under the plasma forming conditions. Such components may be side phases which are comprised in the precursor compound of the electride compound and/or or phases which are formed during heating under the plasma forming conditions. Typical side phases which may occur include calcium oxide, aluminum oxides like alpha alumina, theta alumina or gamma alumina, mixed calcium aluminum oxides like Ca₃Al₂O₆ (tricalcium aluminate) or CaAl₂O₃ (krotite), carbides or oxycarbides of aluminum, calcium and/or other elements employed in the synthesis of the precursor compound, silicon, aluminum, calcium in metallic form, silicates of aluminum, siliicates of calcium and/or silicates of other elements. Typical contents of such side phases in the composite material may be in the range of from 0.01 to 15 weight-%, preferably in the range of from 0.1 to 10 weight-%, more preferably in the range of from 0.5 to 8 weight-%, based on the total weight of the composite material.

Preferably, the composite material exhibits an XRD pattern comprising a 211 reflection and a 420 reflection, wherein the intensity ratio of the 211 reflection relative to the 420 reflection is greater than 1:1, preferably in the range of from 1.1:1 to 2.1:1, more preferably in the range of from 1.3:1 to 2.1:1, determined as described in Reference Example 1.2.

It is preferred that the composite material exhibits an EPR spectrum comprising resonances in the range of from 335 to 345 mT, determined as described in Reference Example 1.3.

Further, the composite material comprising an electride compound and an additive, preferably obtainable or obtained or preparable or prepared by the inventive process, can be used as a catalyst or a catalyst component, preferably in a chemical reaction comprising hydrogen (H₂) activation, nitrogen activation (N₂), or in an amination reaction, more preferably in a hydrogenation reaction, more preferably for the hydrogenation of an olefin, an aromatic compound, an acetylenic compound, an aldehyde, a carboxylic acid, an ester, an imine, a nitrile, a nitro compound (a compound comprising a nitro group (—NO₂)), nitric acid, a carboxylic acid chloride, an ether and/or an acetal, or more preferably for preparing ammonia starting from nitrogen and hydrogen.

The present invention also relates to a method for preparing ammonia, comprising bringing a mixture comprising nitrogen and hydrogen in contact with a catalyst comprising said composite material.

The present invention is further illustrated by the following embodiments and combinations of embodiments as indicated by the respective dependencies and back-references. In particular, it is noted that if a range of embodiments is mentioned, for example in the context of a term such as “The process of any one of embodiments 1 to 4”, every embodiment in this range is meant to be disclosed for the skilled person, i.e. the wording of this term is to be understood by the skilled person as being synonymous to “The process of any one of embodiments 1, 2, 3, and 4”.
1. A process for preparing a composite material comprising an electride compound and an additive, said process comprising
   (i) providing a composition comprising the additive and a precursor compound of the electride compound, wherein the precursor compound comprises an oxidic compound of the garnet group, and wherein the additive has a boiling temperature which is higher than the melting temperature of the precursor compound;
   (ii) heating the composition provided in (i) under plasma forming conditions in a gas atmosphere to a temperature above the Hüttig temperature of the precursor compound and below the boiling temperature of the additive, obtaining the composite material.
2. The process of embodiment 1, wherein according to (ii), heating the composition under plasma forming conditions comprises heating the composition in an electric arc.
3. The process of embodiment 2, comprising
   (i) providing a composition comprising the additive and a precursor compound of the electride compound, wherein the precursor compound comprises an oxidic compound of the garnet group, and wherein the additive has a boiling temperature which is higher than the melting temperature of the precursor compound;
   (ii) heating the composition provided in (i) in an electric arc in a gas atmosphere to a temperature above the Hüttig temperature of the precursor compound and below the boiling temperature of the additive, obtaining the electride compound.
4. The process of any one of embodiments 1 to 3, wherein according to (ii), the composition provided in (i) is heated to a temperature above the Tamman temperature of the precursor compound and below the boiling temperature of the additive.
5. The process of any one of embodiments 1 to 4, wherein according to (ii), the composition provided in (i) is heated to a temperature above the melting temperature of the precursor compound and below the boiling temperature of the additive.
6. The process of any one of embodiments 1 to 5, wherein the oxidic compound of the garnet group according to (i) comprises aluminum.
7. The process of any one of embodiments 1 to 6, wherein the oxidic compound of the garnet group according to (i) comprises calcium.
8. The process of any one of embodiments 1 to 7, wherein the oxidic compound of the garnet group according to (i) comprises one or more of magnesium, gallium, silicon, germanium, tin, strontium, titanium, zirconium, chromium, manganese, iron, cobalt, nickel, copper, and zinc.
9. The process of any one of embodiments 1 to 8, wherein at least 90 weight-%, preferably at least 95 weight-%, more preferably at least 99 weight-%, more preferably at least 99.5 weight-%, more preferably at least 99.9 weight-% of the oxidic compound of the garnet group consist of calcium, aluminum, and oxygen.
10. The process of any one of embodiments 1 to 9, wherein the oxidic compound of the garnet group according to (i) comprises calcium and aluminum at an elemental ratio Ca:Al in the range of from 11.5:14 to 12.5:14, preferably in the range of from 11.8:14 to 12.2:14, more preferably in the range of from 11.9:14 to 12.1:14.
11. The process of any one of embodiments 1 to 10, wherein the oxidic compound of the garnet group according to (i) comprises calcium and aluminum at an elemental ratio Ca:Al of 12:14.
12. The process of any one of embodiments 1 to 11, wherein the oxidic compound of the garnet group according to (i) comprises calcium and oxygen at an elemental ratio Ca:O in the range of from 11.5:33 to 12.5:33, preferably in the range of from 11.8:33 to 12.2:33, more preferably in the range of from 11.9:33 to 12.1:33.
13. The process of any one of embodiments 1 to 12, wherein the oxidic compound of the garnet group according to (i) comprises calcium and oxygen at an elemental ratio Ca:O of 12:33.
14. The process of any one of embodiments 1 to 13, wherein the oxidic compound of the garnet group is a crystalline material exhibiting cubic structure and crystallographic space group I-43d.
15. The process of any one of embodiments 1 to 14, wherein the oxidic compound of the garnet group comprises, preferably is a mayenite.
16. The process of any one of embodiments 1 to 15, wherein the oxidic compound of the garnet group comprises, preferably is a compound Ca₁₂Al₁₄O₃₃.
17. The process of any one of embodiments 1 to 16, wherein at least 80 weight-%, preferably at least 85 weight-%, more preferably at least 90 weight-%, more preferably at least 95 weight-%, more preferably at least 99 weight-% of the precursor compound consist of an oxidic compound of the garnet group.
18. The process of any one of embodiments 1 to 17, wherein the precursor compound has a BET specific surface area, determined according to ISO 9277, of at least 2 m²/g, preferably of at least 3 m²/g, more preferably of at least 5 m²/g, more preferably in the range of from 5 to 1000 ²/g, more preferably in the range of from 5 to 500 m²/g, more preferably in the range of from 5 to 100 m²/g.
19. The process of any one of embodiments 1 to 18, wherein the precursor compound provided according to (i) is in the form of particles having a mean particle size, determined as described in Reference Example 1.7, in the range of from 1 to 2000 micrometer, preferably in the range of from 10 to 500 micrometer, more preferably in the range of from 20 to 200 micrometer.
20. The process of any one of embodiments 1 to 19, wherein the additive has a boiling temperature which is at least 20° C., preferably at least 50° C., more preferably at least 100° C., more preferably at least 150° C., more preferably at least 200° C. higher than the melting temperature of the precursor compound.
21. The process of any one of embodiments 1 to 20, wherein the additive comprises a metal compound, a semi-metal compound or a non-metal compound which is an oxygen getter material reducing the oxygen partial pressure during heating under plasma conditions according to (ii).
22. The process of any one of embodiments 1 to 21, wherein the additive comprises an element of group IIIA or group IVA of the periodic table.
23. The process of any one of embodiments 1 to 22, wherein the additive comprises one or more of aluminum, calcium, titanium, zirconium, tungsten, niobium, tantalum, carbon, and silicon, more preferably comprises, more preferably is one or more of aluminum, graphite, alpha silicon carbide (alpha SiC) and beta silicon carbide (beta SiC).
24. The process of any one of embodiments 1 to 23, wherein the additive comprises micropores, or mesopores, or macropores, or micropores and mesopores, or micropores and macropores, or mesopores and macropores, or micropores and mesopores and macropores, preferably mesopores and macropores, more preferably macropores, wherein a micropore has a diameter of less than 2 nm, a mesopore has a diameter in the range of from 2 to 50 nm, and a macropore has a diameter of more than 50 nm.
25. The process of any one of embodiment 1 to 24, wherein the additive has a BET specific surface area in the range of from 2 to 1000 m²/g, preferably in the range of from 3 to 500 m²/g, more preferably in the range of from 5 to 100 m²/g.
26. The process of any one of embodiments 1 to 25, wherein the additive is in the form of a powder and/or a granulate.
27. The process of embodiment 26, wherein the additive has a mean particle size in the range of from 1 to 100 micrometer, preferably in the range of from 3 to 50 micrometer, more preferably in the range of from 5 to 30 micrometer.
28. The process of any one of embodiments 1 to 25 wherein the additive is in the form of a molding.
29. The process of embodiment 28, wherein the molding is one or more of a flake, a sphere, a tablet, a star, a strand, a brick optionally having one or more channels with an open inlet end and an open outlet end, an optionally hollow cylinder, and a porous foam.
30. The process of embodiment 28 or 29, wherein the additive comprises, preferably is a molding comprising, preferably consisting of silicon carbide.
31. The process of any one of embodiments 1 to 30, wherein providing the composition according to (i) comprises
   (i.1) providing the precursor compound and providing the additive;
   (i.2) preparing the composition comprising the additive and the precursor compound provided in (i.1).
32. The process of embodiment 31, wherein providing the precursor compound according to
   (i. 1) comprises
   (i.1.1) preparing a mixture comprising a source of calcium, a source of aluminum, and water;
   (i.1.2) optionally subjecting the mixture prepared in (i.1.1) to a hydrothermal treatment;
   (i.1.3) calcining the mixture prepared in (i.1), optionally the mixture obtained from (i.1.2), obtaining the precursor compound.
33. The process of embodiment 32, wherein the source of calcium is one or more of a calcium oxide, a calcium hydroxide, a hydrated calcium oxide, and a calcium carbonate.
34. The process of embodiment 32 or 33, wherein the source of calcium is a calcium oxide, preferably CaO.
35. The process of any one of embodiments 32 to 34, wherein the source of aluminum is one or more of an aluminum hydroxide including one or more of gibbsite, hydrargillite, bayerite, doyleite, nordstrandite, and gel-like amorphous aluminum hydroxide, an aluminum oxyhydroxide (AlO(OH)) including one or more of pseudo-boehmite, boehmite, diaspor, and akdalaite, and an aluminum oxide including one or more of gamma aluminum oxide, chi aluminum oxide, delta aluminum oxide, eta aluminum oxide, rho aluminum oxide and kappa aluminum oxide.
36. The process of any one of embodiments 32 to 35, wherein the source of aluminum is one or more of gamma alumina, gamma aluminum oxyhydroxide (boehmite) and a pseudo boehmite, preferably gamma aluminum oxyhydroxide.
37. The process of any one of embodiments 32 to 36, wherein in the mixture prepared in (i.1.1), the molar ratio of the source of calcium relative to the source of aluminum, preferably the molar ratio of the calcium oxide relative to the gamma aluminum oxyhydroxide, is in the range of from 11.90:14 to 12.10:14, preferably in the range of from 11.95 to 12.05:14, more preferably in the range of from 11.99:14 to 12.01:14.
38. The process of any one of embodiments 32 to 37, wherein in the mixture prepared in (i.1.1), the molar ratio of the source of calcium relative to the source of aluminum, preferably the molar ratio of the calcium oxide relative to the gamma aluminum oxyhydroxide, is 12.00:14.00.
39. The process of any one of embodiments 32 to 38, wherein in the mixture prepared in (i.1.1), the molar ratio of the water relative to the source of aluminum, preferably the gamma aluminum oxyhydroxide expressed as ratio of water (H₂O) to aluminum (Al), is in the range of from 0.1:1 to 50:1, preferably in the range of from 0.2:1 to 30:1, more preferably in the range of from 0.3:1 to 20:1, more preferably in the range of from 0.5:1 to 10:1.
40. The process of any one of embodiments 32 to 39, wherein preparing the mixture according to (i.1.1) comprises agitating the mixture, preferably mechanically agitating the mixture.
41. The process of embodiment 40, wherein agitating the mixture comprises milling the mixture.
42. The process of any one of embodiments 32 to 41, wherein according to (i.1.3), the mixture is calcined in a gas atmosphere, wherein the gas atmosphere comprises oxygen, wherein more preferably, the gas atmosphere is oxygen, air, lean air, or synthetic air.
43. The process of embodiment 42, wherein the gas atmosphere is a gas stream and the mixture is calcined at a flow rate of the gas stream in the range of from 1 to 10 L/min, preferably in the range of from 3 to 9 L/min, more preferably in the range of from 5 to 8 L/min.
44. The process of embodiment 42 or 43, wherein the gas atmosphere has a temperature in the range of from 400 to 1400° C., preferably in the range of from 500 to 1350° C., more preferably in the range of from 600 to 1300° C., more preferably in the range of from 700 to 1300° C., more preferably in the range of from 750 to 1250° C.
45. The process of embodiment 44, wherein the mixture is heated to the temperature at a heating rate in the range of from 1 to 8 K/min, preferably in the range of from 2 to 7 K/min, more preferably in the range of from 3 to 6 K/min.
46. The process of any one of embodiments 32 to 45, wherein according to (i.1.2), the mixture prepared in (i.1.1) is subjected to a hydrothermal treatment.
47. The process of embodiment 46, wherein according to (i.1.2), the mixture is heated under autogenous pressure, preferably in an autoclave, to a temperature in the range of from 35 to 250° C., preferably in the range of from 40 to 200° C., more preferably in the range of from 50 to 150° C.
48. The process of embodiment 47, wherein the mixture is kept at this temperature for a period of time of at most 90 h, preferably at most 70 h, more preferably at most 50 h.
49. The process of embodiment 47 or 48, wherein the mixture is kept at this temperature for a period of time in the range of from 1 to 90 h, preferably in the range of from 3 to 70 h, more preferably in the range of from 6 to 50 h.
50. The process of any one of embodiment 46 to 49, wherein (i.1.2) further comprises drying the mixture obtained from the hydrothermal treatment, preferably in a gas atmosphere, wherein the gas atmosphere preferably comprises oxygen, wherein more preferably, the gas atmosphere is oxygen, air, lean air, or synthetic air, and wherein the gas atmosphere has a temperature preferably in the range of from 40 to 150° C., more preferably in the range of from 50 to 120° C., more preferably in the range of from 60 to 100° C.
51. The process of any one of embodiments 46 to 50, wherein in the mixture prepared in (i.1.1), the molar ratio of the water relative to the source of aluminum, preferably the gamma aluminum oxyhydroxide, calculated as elemental aluminum, is in the range of from 0.1:1 to 50:1, preferably in the range of from 0.2:1 to 30:1, more preferably in the range of from 0.3:1 to 20:1, more preferably in the range of from 0.5:1 to 10:1.
52. The process of any one of embodiments 46 or 51, wherein according to (i.1.3), the mixture is calcined in a gas atmosphere, wherein the gas atmosphere comprises nitrogen and/or oxygen, wherein more preferably, the gas atmosphere is oxygen, air, lean air, or synthetic air.
53. The process of embodiment 52, wherein the gas atmosphere has a temperature in the range of from 400 to 1400° C., preferably in the range of from 400 to 1200° C., more preferably in the range of from 400 to 1000° C., more preferably in the range of from 400 to 800° C.
54. The process of any one of embodiments 31 to 53, wherein preparing the composition according to (i.2) comprises mixing the additive with the precursor compound.
55. The process of embodiment 54, wherein for mixing the additive with the precursor compound, an adjuvant is employed enhancing the adhesion between additive and the precursor compound.
56. The process of embodiment 55, wherein the adjuvant comprises one or more of water, glycerol, an alkane, an aqueous methyl cellulose solution, an ethylene glycol, a polyethylene glycol, a polypropylene glycol, a polyvinyl pyrrolidone, and a polyvinyl alcohol.
57. The process of any one of embodiments 54 to 56, wherein mixing the additive with the precursor compound comprises mixing in a tumbler blender, a convective blender, or a fluidization blender.
58. The process of any one of embodiments 54 to 57, wherein preparing the composition according to (i.2) further comprises compacting the composition obtained from mixing.
59. The process of any one of embodiments 54 to 57, wherein preparing the composition according to (i.2) further comprises extruding the composition obtained from mixing.
60. The process of any one of embodiments 1 to 59, wherein the composition provided in (i) is in the form of a molding.
61. The process of embodiment 60, wherein the molding is one or more of a flake, a sphere, a tablet, a star, a strand, a brick optionally having one or more channels with an open inlet end and an open outlet end, an optionally hollow cylinder, and a porous foam.
62. The process of any one of embodiments 1 to 61, wherein at least 90 weight-%, preferably at least 95 weight-%, more preferably at least 98 weight-% of the composition provided in (i) consist of the additive, the precursor compound and optionally an adjuvant as defined in embodiment 55 or 56.
63. The process of any one of embodiments 1 to 62, wherein in the composition provided in (i), the weight ratio of the precursor compound relative to the additive is in the range of from 0.01:1 to 1000:1, preferably in the range of from 0.1:1 to 500:1, more preferably in the range of from 1:1 to 90:1.
64. The process of any one of embodiments 1 to 63, wherein the heating according to (ii) is carried out in an electric arc furnace which comprises a first electrode and a second electrode between which the electric arc is formed, wherein on the second electrode, the composition provided in (i) to be heated is positioned, and wherein during heating according to (ii), the electrical power of the light arc between the first electrode and the second electrode is in the range of from 100 to 4000 W, preferably in the range of from 500 to 3000 W, more preferably in the range of from 750 to 2000 W.
65. The process of embodiment 64, wherein the electric arc furnace further comprises a gas-tight housing enclosing the first electrode and the second electrode, and further enclosing the gas atmosphere according to (ii), wherein the first electrode is positioned vertically above the second electrode, and wherein the gas-tight housing comprises means for at least partially removing a gas atmosphere from the housing and for feeding a gas atmosphere into the housing.
66. The process of embodiment 64 or 65, wherein the first electrode comprises tungsten, a mixture of tungsten with zirconium oxide, a mixture of tungsten with thorium oxide, a mixture of tungsten with lanthanum oxide, or a mixture of tungsten with copper oxide, preferably comprises tungsten, more preferably is a tungsten electrode, and wherein the second electrode comprises one or more of metals selected from the group consisting of tungsten, copper, niobium, molybdenum, tantalum, and chromium, preferably comprises copper, more preferably is a copper electrode.
67. The process of any one of embodiments 1 to 66, wherein according to (ii), the composition provided in (i) is heated under plasma forming conditions for a period of time in the range of from 1 to 350 s, preferably in the range of from 2 to 90 s, more preferably in the range of from 5 to 75 s
68. The process of any one of embodiments 1 to 67, wherein during heating the composition provided in (i) under plasma forming conditions according to (ii), the gas atmosphere has a pressure of less than 1 bar(abs), preferably in the range of from 0.3 to 0.9 bar(abs), more preferably in the range of from 0.6 to 0.8 bar(abs) or wherein during heating the composition provided in (i) under plasma forming conditions according to (ii), the gas atmosphere has a pressure of at least 1 bar(abs), preferably in the range of from 1 to 30 bar(abs), more preferably in the range of from 2 to 10 bar(abs).
69. The process of any one of embodiments 1 to 68, wherein at the beginning of the heating according to (ii), the temperature of the gas atmosphere is in the range of from 10 to 50° C., preferably in the range of from 15 to 40° C., more preferably in the range of from 20 to 30° C.
70. The process of any one of embodiments 1 to 69, wherein heating the composition provided in (i) under plasma forming conditions according to (ii) is carried out under oxygen (O₂) removal conditions.
71. The process of embodiment 70, wherein the oxygen removal conditions comprise physical oxygen removal conditions and/or chemical oxygen removal conditions.
72. The process of embodiment 71, wherein the chemical oxygen removal conditions comprise a gas atmosphere according to (ii) which comprises an oxygen reducing gas.
73. The process of embodiment 72, wherein the oxygen reducing gas comprises one or more of nitrogen (N₂), methane and hydrogen (H₂), preferably comprises, more preferably consists of hydrogen.
74. The process of embodiment 72 or 73, wherein at least 0.5 volume-%, preferably at least 5 volume-%, more preferably at least 50 volume-%, preferably at least 80 volume-%, more preferably at least 90 volume-% of the gas atmosphere consist of hydrogen.
75. The process of any one of embodiments 72 to 74, wherein the gas atmosphere according to (ii) comprises a gas which is ionizable under the plasma forming conditions according to (ii).
76. The process of embodiment 75, wherein the gas which is ionizable under the plasma forming conditions comprises one or more noble gases, preferably one or more of helium, neon, argon, krypton, xenon, more preferably one or more of helium, neon and argon, wherein more preferably, the gas which is ionizable under the plasma forming conditions comprises argon.
77. The process of embodiment 76, wherein at least 99 volume-%, preferably at least 99.5 volume-%, more preferably at least 99.9 volume-% of the gas which is ionizable under the plasma forming conditions consist of argon.
78. The process of any one of embodiments 72 to 77, wherein the gas atmosphere according to (ii) comprises an oxygen reducing gas and a gas which is ionizable under the plasma forming conditions, wherein at the beginning of the heating according to (ii) in the gas atmosphere, the volume ratio of the oxygen reducing gas relative to the gas which is ionizable under the plasma forming conditions is in the range of from 1:99 to 10:90, preferably in the range of from 2:98 to 8:92, more preferably in the range of from 4:96 to 6:94.
79. The process of embodiment 78, wherein at the beginning of the heating according to (ii), at least 99 volume-%, preferably at least 99.5 volume-%, more preferably at least 99.9 volume-% of the gas atmosphere consist of the oxygen reducing gas and the gas which is ionizable under the plasma forming conditions.
80. The process of any one of embodiment 71 to 79, wherein the physical oxygen removal conditions comprise
   (ii.1) heating the composition provided in (i) in the gas atmosphere under plasma forming conditions for a period of time delta₁t, wherein the gas atmosphere comprises a gas which is ionizable under the plasma forming;
   (ii.2) at least partially removing the gas atmosphere after the period of time delta₁t and providing a fresh gas atmosphere comprising a gas which is ionizable under the plasma forming conditions;
   (ii.3) further heating of the composition obtained from (ii.2) in the fresh gas atmosphere under plasma forming conditions for a period of time delta₂t.
81. The process of embodiment 80, wherein the gas which is ionizable under the plasma forming conditions according to (ii.1) comprises one or more noble gases, preferably one or more of helium, neon, argon, krypton, xenon, more preferably one or more of helium, neon and argon, wherein more preferably, the gas which is ionizable under the plasma forming conditions comprises argon.
82. The process of embodiment 81, wherein at least 99 volume-%, preferably at least 99.5 volume-%, more preferably at least 99.9 volume-% of the gas which is ionizable under the plasma forming conditions according to (ii.1) consist of argon.
83. The process of any one of embodiments 80 to 82, wherein the gas atmosphere according to (ii.1) further comprises an oxygen reducing gas which preferably comprises one or more of nitrogen (N₂) and hydrogen (H₂), more preferably comprises, more preferably consists of hydrogen.
84. The process of embodiment 83, wherein at the beginning of the heating in the gas atmosphere according to (ii.1), the volume ratio of the oxygen reducing gas relative to the gas which is ionizable under plasma forming conditions according to (ii.1) is in the range of from 1:99 to 10:90, preferably in the range of from 2:98 to 8:92, more preferably in the range of from 4:96 to 6:94.
85. The process of embodiment 83, wherein at the beginning of the heating in the gas atmosphere according to (ii.1), the volume ratio of the oxygen reducing gas relative to the gas which is ionizable under plasma forming conditions according to (ii.1) is in the range of from 0:100 to 1:99, preferably in the range of from 0:100 to 0.5:99.5, more preferably in the range of from 0:100 to 0.1:99.9.
86. The process of any one of embodiments 81 to 85, wherein at the beginning of the heating according to (ii.1), at least 99 volume-%, preferably at least 99.5 weight-%, more preferably at least 99.9 weight-% of the gas atmosphere consist of the gas which is ionizable under the plasma forming conditions and optionally the oxygen reducing gas.
87. The process of any one of embodiments 80 to 86, wherein at the beginning of the heating according to (ii.1), the temperature of the gas atmosphere is in the range of from 10 to 50° C., preferably in the range of from 15 to 40° C., more preferably in the range of from 20 to 30° C.
88. The process of any one of embodiments 80 to 87, wherein the gas which is ionizable under the plasma forming conditions according to (ii.3) comprises one or more noble gases, preferably one or more of helium, neon, argon, krypton, xenon, more preferably one or more of helium, neon and argon, wherein more preferably, the gas which is ionizable under the plasma forming conditions comprises argon.
89. The process of embodiment 88, wherein at least 99 volume-%, preferably at least 99.5 volume-%, more preferably at least 99.9 volume-% of the gas which is ionizable under the plasma forming conditions according to (ii.3) consist of argon.
90. The process of embodiment 88 or 89, wherein the gas atmosphere according to (ii.3) further comprises an oxygen reducing gas which preferably comprises one or more of nitrogen (N₂) and hydrogen (H₂), more preferably comprises, more preferably consists of hydrogen.
91. The process of embodiment 90, wherein at the beginning of the heating in the gas atmosphere according to (ii.3), the volume ratio of the oxygen reducing gas relative to the gas which is ionizable under plasma forming conditions according to (ii.3) is in the range of from 1:99 to 10:90, preferably in the range of from 2:98 to 8:92, more preferably in the range of from 4:96 to 6:94.
92. The process of embodiment 91, wherein at the beginning of the heating in the gas atmosphere according to (ii.1), the volume ratio of the oxygen reducing gas relative to the gas which is ionizable under plasma forming conditions according to (ii.3) is in the range of from 0:100 to 1:99, preferably in the range of from 0:100 to 0.5:99.5, more preferably in the range of from 0:100 to 0.1:99.9.
93. The process of any one of embodiments 88 to 92, wherein at the beginning of the heating according to (ii.3), at least 99 volume-%, preferably at least 99.5 weight-%, more preferably at least 99.9 weight-% of the gas atmosphere consist of the gas which is ionizable under the plasma forming conditions and optionally the oxygen reducing gas.
94. The process of any one of embodiments 80 to 93, wherein at the beginning of the heating according to (ii.3), the temperature of the gas atmosphere is in the range of from 10 to 50° C., preferably in the range of from 15 to 40° C., more preferably in the range of from 20 to 30° C.
95. The process of any one of embodiments 80 to 94, wherein (delta₁t+delta₂t) is in the range of from 1 to 350 s, preferably in the range of from 2 to 90 s, more preferably in the range of from 5 to 75 s.
96. The process of any one of embodiments 80 or 95, wherein after (ii.3), removing the gas atmosphere, providing a fresh gas atmosphere and further heating the composition in the fresh gas atmosphere is repeated at least once, wherein the total heating time according to (ii) is preferably in the range of from 1 to 350 s, more preferably in the range of from 2 to 90 s, more preferably in the range of from 5 to 75 s.
97. The process of any one of embodiments 1 to 96, further comprising
   (iii) cooling the composite material obtained from (ii).
98. A composite material comprising an electride compound and an additive, obtainable or obtained or preparable or prepared by a process according to any one of embodiments 1 to 97.
99. A composite material comprising an electride compound and an additive, preferably the composite material according to embodiment 98, wherein the additive comprises an element of group IIIA or group IVA of the periodic table.
100. The composite material of embodiment 99, wherein the additive comprises one or more of aluminum, carbon, and silicon, more preferably comprises, more preferably is one or more of aluminum, graphite, alpha silicon carbide (alpha SiC) and beta silicon carbide (beta SiC).
101. The composite material of embodiment 99 or 100, wherein the electride compound is obtainable or obtained from an oxidic compound of the garnet group by heating under plasma forming conditions as defined in any one of embodiments 64 to 96.
102. The composite material of embodiment 101, wherein the oxidic compound of the garnet group comprises aluminum.
103. The composite material of embodiment 101 or 102, wherein the oxidic compound of the garnet group comprises calcium.
104. The composite material of any one of embodiments 101 to 103, wherein the oxidic compound of the garnet group comprises one or more of magnesium, gallium, silicon, germanium, tin, strontium, titanium, zirconium, chromium, manganese, iron, cobalt, nickel, copper, and zinc.
105. The composite material of any one of embodiments 101 to 104, wherein at least 90 weight-%, preferably at least 95 weight-%, more preferably at least 99 weight-%, more preferably at least 99.5 weight-%, more preferably at least 99.9 weight-% of the oxidic compound of the garnet group consist of calcium, aluminum, and oxygen.
106. The composite material of any one of embodiments 101 to 105, wherein the oxidic compound of the garnet group comprises calcium and aluminum at an elemental ratio Ca:Al in the range of from 11.5:14 to 12.5:14, preferably in the range of from 11.8:14 to 12.2:14, more preferably in the range of from 11.9:14 to 12.1:14.
107. The composite material of any one of embodiments 101 to 106, wherein the oxidic compound of the garnet group comprises calcium and aluminum at an elemental ratio Ca:Al of 12:14.
108. The composite material of any one of embodiments 101 to 107, wherein the oxidic compound of the garnet group comprises calcium and oxygen at an elemental ratio Ca:O in the range of from 11.5:33 to 12.5:33, preferably in the range of from 11.8:33 to 12.2:33, more preferably in the range of from 11.9:33 to 12.1:33.
109. The composite material of any one of embodiments 101 to 108, wherein the oxidic compound of the garnet group comprises calcium and oxygen at an elemental ratio Ca:O 12:33.
110. The composite material of any one of embodiments 101 to 109, wherein the oxidic compound of the garnet group is a crystalline material exhibiting cubic structure and crystallographic space group I-43d.
111. The composite material of any one of embodiments 101 to 110, wherein the oxidic compound of the garnet group comprises, preferably is a mayenite.
112. The composite material of any one of embodiments 1 to 111, wherein the oxidic compound of the garnet group comprises, preferably is a compound Ca₁₂Al₁₄O₃₃.
113. The composite material of any one of embodiments 99 to 112, being a porous composition and having micropores, or mesopores, or macropores, or micropores and mesopores, or micropores and macropores, or mesopores and macropores, or micropores and mesopores and macropores, preferably having mesopores and macropores, more preferably having macropores, wherein a micropore has a diameter of less than 2 nm, a mesopore has a diameter in the range of from 2 to 50 nm, and a macropore has a diameter of more than 50 nm.
114. The composite material of any one of embodiments 99 to 113, having a BET specific surface area of at least 2 m²/g, preferably of at least 3 m²/g, more preferably of at least 5 m²/g.
115. The composite material of any one of embodiments 99 to 114, having a BET specific surface area in the range of from 2 to 1000 m²/g, preferably in the range of from 3 to 500 m²/g, more preferably in the range of from 5 to 250 m²/g.
116. The composite material of any one of embodiments 99 to 115, wherein in the composite material, the weight ratio of the electride compound relative to the additive is in the range of from 0.01:1 to 15:1, preferably in the range of from 0.1:1 to 500:1, more preferably in the range of from 1:1 to 90:1.
117. The composite material of any one of embodiments 99 to 116, exhibiting an XRD pattern comprising a 211 reflection and a 420 reflection, wherein the intensity ratio of the 211 reflection relative to the 420 reflection is greater than 1:1, preferably in the range of from 1.1:1 to 2.1:1, more preferably in the range of from 1.3:1 to 2.1:1, determined as described in Reference Example 1.2.
118. The composite material of any one of embodiments 99 to 117, exhibiting an EPR spectrum comprising resonances in the range of from 335 to 345 mT, determined as described in Reference Example 1.3.
119. Use of a composite material according to any one of embodiments 98 to 118 as a catalyst or a catalyst component, preferably as a basic catalyst or as a basic catalyst component.
120. The use of embodiment 119 in a chemical reaction comprising hydrogen (H₂) activation, nitrogen activation (N₂), or in an amination reaction.
121. The use of embodiment 119 or 120 in a hydrogenation reaction, preferably for the hydrogenation of an olefin, an aromatic compound, an acetylenic compound, an aldehyde, a carboxylic acid, an ester, an imine, a nitrile, a nitro compound, nitric acid, a carboxylic acid chloride, an ether and/or an acetal.
122. The use of embodiment 120 for preparing ammonia starting from nitrogen and hydrogen.
123. A method for activating hydrogen (H₂) or nitrogen (N₂) in a chemical reaction, comprising bringing said hydrogen in contact with a catalyst comprising a composite material according to any one of embodiments 98 to 118.
124. The method of embodiment 123, comprising a hydrogenation reaction, preferably the hydrogenation of an olefin, an aromatic compound, an acetylenic compound, an aldehyde, a carboxylic acid, an ester, an imine, a nitrile, a nitro compound, nitric acid, a carboxylic acid chloride, an ether and/or an acetal.
125. A method for preparing ammonia, comprising bringing a mixture comprising nitrogen and hydrogen in contact with a catalyst comprising a composite material according to any one of embodiments 98 to 118.

The present invention is further illustrated by the following reference examples, examples, and comparative examples.

### EXAMPLES

### Reference Example 1: Methods

For preparing the electride compounds of the present invention, an electric arc furnace MAM-1, Edmund Bühler GmbH, Germany, was used. The general set-up of this furnace is shown in FIG. 1 and FIG. 2. Generally, the electrical arc can be operated at 10 different intensity level settings provided by the apparatus. The respective setting is regulated with a knob at the control unit of the furnace. The electrical power of the respective intensity levels were measured with an ampere- and voltmeter directly connected to the electrodes. The intensity levels of the electrical arc furnace correspond linearly to the electrical power independent from the atmosphere used. This linear dependence is shown in FIG. 3. The values of the electrical power corresponding to the intensity levels are shown in Table 1 below:

TABLE 1
Intensity levels/Electrical power

| Intensity level | Electrical power/W |
|---|---|
| 1 | 110 |
| 2 | 519 |
| 3 | 928 |
| 4 | 1337 |
| 5 | 1746 |
| 6 | 2155 |
| 7 | 2564 |
| 8 | 2973 |
| 9 | 3382 |
| 10 | 3791 |

### Reference Example 1.2: XRD Analysis

The samples of the calcium aluminum oxides and the electride materials based thereon were analyzed regarding their phase purity and crystallinity by XRD using a Bruker D8 Advance diffractometer from Bruker AXS GmbH, Karlsruhe equipped with a Lynxeye XE 1D-Detector, using variable slits, from 5° to 75° 2theta. The anode of the X-ray tube consisted of copper. To suppress the Cu radiation, a nickel filter was used. The following parameters were used:
Voltage: 40 kV
Current: 40 mA
Step size: 0.02° 2theta
Scan speed 0.2 s/step
Soller slits (primary side): 2.5°
Soller slits (secondary side): 2.5°
Divergence slit: 0.17°

### Reference Example 1.3: EPR Analysis

EPR spectra were recorded using a MS100 X-Band-EPR spectrometer from Magnettech GmbH with amplifying and modulation amplitude adjusted to the respective sample. Overview spectra were recorded with a field of 500-4500 G, a sweep time of 41 s and 4096 data points. Quantitative spectra were recorded with a field of 3414 G, a sweep width of 500 G and a sweep time of 41 sin five runs.

### Reference Example 1.4: Preparing Tablets

Tablets were prepared using a MP250M press, Massen GmbH, Germany, equipped with a pressure gauge. For the preparation of tablets 0.5 g of material was used and pressed at with a force of 10 t. All tablets prepared were of circular shape, with a diameter of 13 mm and a height of 4 mm.

### Reference Example 1.5: Determination of the Water Content

The water content was analyzed in the drying and ashing system prepASh, Precisa Gravimetrics AG, Switzerland. Samples were heated to 1000° C. and the weight loss was monitored.

### Reference Example 1.6: General Procedure to Prepare Tablets with an Additive

Materials used:

Mayenite: from Example 1; also possible: from Example 2
Graphite: Fischer chemicals, general purpose grade
Aluminum: Alfa Aesar, 99.5%, −325 mesh
Silicon: Alfa Aesar, 98%, −140 mesh
Calcium: Alfa Aesar, 99.5%, −16 mesh
beta SiC: SICAT SARI, UHP grade

The respective amount of mayenite powder and the desired amount of additive were manually mixed in a small glass vial to yield a mixture with a total weight of 0.5 g. The mixture was then pressed into tablets with 13 mm diameter and 4 mm height with a pressure of 10 t. The composition of the respectively prepared tablets is shown in Table 2 below:

TABLE 2
Composition of the tablets prepared

| Mass mayenite/g | Mass additive/g | Weight-% additive in tablet |
|---|---|---|
| 0.485 | 0.015 | 3 |
| 0.475 | 0.025 | 5 |
| 0.45 | 0.05 | 10 |
| 0.40 | 0.10 | 20 |
| 0.35 | 0.15 | 30 |
| 0.30 | 0.20 | 40 |
| 0.25 | 0.25 | 50 |
| 0.20 | 0.30 | 60 |
| 0.15 | 0.35 | 70 |
| 0.10 | 0.40 | 80 |
| 0.05 | 0.45 | 90 |
| 0.025 | 0.475 | 95 |

### Reference Example 1.7: Determination of Particle Size

The particle size was determined via laser diffraction using a Malvern Mastersizer 3000.

### Reference Example 1.8: Kubelka-Munk Transformed Absorption Spectra

Kubelka-Munk transformed absorption spectra were obtained as follows: UV-Vis reflectance spectra were recorded on a Perkin Elmer Lambda 950 Spectrophotometer with an Ulbricht sphere. The obtained reflectance spectra were transformed using the Kubelka-Munk equation:

F(R)=(1−R)²/2R

The electron concentration Nₑ was then determined with the equation according to the literature:

Nₑ=[−(Eₛₚ−Eₛₚ⁰/0.119]^{0.782}

wherein Eₛₚ⁰=2.83 eV and Eₛₚ is the energy of the respective maxima between 2.5 and 3.0 eV.

### Example 1: Preparing a Precursor Compound Having the Composition Ca₁₂Al₁₄O₃₃

Materials used:

AlO(OH) (Disperal®, Boehmite) from Sasol
Calcium oxide (CaO) from Alfa Aesar (ordering number 33299)
The water content was determined as described in Reference Example 1.5. For AlO(OH), an average weight loss of 23.37% was determined, for CaO an average weight loss 3.57%. Table 3 below shows the respective results:

TABLE 3
Weight losses of the
starting materials for preparing the precursor compound

| | mass before | mass after | weight |
|---|---|---|---|
| | heat treatment/g | heat treatment/g | loss/% |
| Disperal ® sample 1 | 1.24 | 0.95 | 23.39 |
| Disperal ® sample 1 | 1.32 | 1.01 | 23.48 |
| Disperal ® sample 1 | 1.21 | 0.93 | 23.14 |
| CaO sample 1 | 1.02 | 0.98 | 3.92 |
| CaO sample 2 | 1.06 | 1.03 | 2.83 |
| CaO sample 3 | 1.01 | 0.97 | 3.96 |

Materials used:

0.43 mol AlO(OH) (Disperal®, Boehmite) from Sasol
0.37 mol Calcium oxide (CaO) from Alfa Aesar
4.2 mol deionized water

0.43 mol of Al(O)OH (28.4 g, including water content), 0.37 mol (21.6 g, including water content) CaO and 4.2 mol (75.7 g) deionized water were combined in a ZrO₂ 250 mL grinding bowl containing 15 Y-stabilized ZrO₂ grinding balls (diameter 20 mm). The bowl was sealed and the mixture ground four times for 10 min each (600 rpm, alternating rotational direction) in a planetary ball mill (“Pulverisette 6 classic line”, Fritsch GmbH), allowing the mixture to cool for five minutes after each grinding procedure. After the final milling run the grinding bowl was left to cool down for 25 min, then opened and the colorless paste transferred to porcelain bowl. The mixture was then calcined in a muffle furnace (M110, Thermo Fisher Scientific Inc,) by raising the temperature at the rate of 5 K/min to 900° C. and keeping it for 8 h under a flow of clean dry air (CDA) with a flow rate of 6 L/min. 50 g of phase pure mayenite were obtained, which was determined by XRD as described in Reference Example 1.2. The XRD diffraction pattern is shown in FIG. 4. The calcium aluminum oxides are characterized by the intensity ratios of the 211 (18.0° 2theta) and 420 (33.4° 2 theta) reflections in their respective diffractograms. In calcium aluminum oxides with mayenite structures the intensity ratio of the 211/420 reflections is below one. The compound prepared according to Example 1 showed an intensity ratio of the 211 reflection relative to the 420 reflection of 0.99:1.

### Example 2: Preparing a Calcium Aluminate Having the Composition Ca₁₂Al₁₄O₃₃ (HydroThermal)

Materials used:

0.34 mol AlO(OH) (Disperal®, Boehmite) from Sasol
17.3 g Calcium oxide (CaO) from Alfa Aesar
60.4 g Deionized water

0.34 mol of Al(O)OH (22.7 g, including water content), 0.30 mol of CaO (17.3 g including water content) and 3.35 mol (60.4 g) of deionized water were placed in a ceramic vessel with eleven ceramic grinding balls (11 mm diameter). The vessel was sealed and the mixture ground in a planetary ball mill (“Pulverisette 6 classic line”, Fritsch GmbH) for 10 min at 600 rpm. The pasty mixture was transferred to a teflon vessel which was placed in a steel autoclave (“DAB-3”, Berghof Products+Instruments GmbH, Germany). The material was then heated to 100° C. and kept at that temperature for 12 h, yielding a thin white suspension. The product was the transferred to a porcelain bowl and dried at 80° C. under air until a dry crystalline solid was obtained which was identified as phase pure Ca₃Al₂(OH)₁₂ (katoite) by XRD. The material was then heated to 600° C. with a rate of 5 K/min and kept at that temperature for eight hours under a flow of clean dry air with a flow rate of 6 L/min, yielding 40 g mayenite which was confirmed by XRD.

### Example 3: Preparing a Composite Material Comprising an Electride Compound Based on Mayenite and Comprising Aluminum

A tablet was prepared according to Reference Example 1.6 containing 0.475 g mayenite of Example 1 (Example 2 also possible) and 0.025 g aluminum. The mayenite/aluminum tablet was placed in the recipient chamber on the copper electrode plate in the electrical arc furnace as described in Reference Example 1.1. The chamber was evacuated for 30 seconds and then flooded with an Ar/H₂ atmosphere (5 volume-% H₂), ultimately adjusting at absolute pressure of 0.7 bar. The electric arc was then ignited at the intensity level 2 and circularly moved around the tablet avoiding the formation of a melt, resulting in an overall electric arc treatment time of 60 s. This procedure was repeated twice. The black pellet was removed from the chamber after wards, crushed and investigated by XRD.

The XRD pattern of the respectively obtained composite material is shown in FIG. 5. The calcium aluminum oxides are characterized by the intensity ratios of the 211 (18.0° 2theta) and 420 (33.4° 2 theta) reflections in their respective diffractograms. In calcium aluminum oxides with mayenite structures the intensity ratio of the 211/420 reflections is below one. In mayenite based electrides prepared in the electrical arc furnace, the intensity ratios are in the range of from above 1.3 to 2.1, depending on the concentration of unbound electrons in the material. The compound prepared according to Example 3 showed an intensity ratio of the 211 reflection relative to the 420 reflection of 1.7.

The EPR spectrum of the respectively obtained material is shown in FIG. 6. The electride materials generally exhibited resonances at a field of 335-345 mT which is in excellent agreement with literature data. To quantify the amount of free electrons in the sample, the spectra were integrated using the FWHM (full width at half maximum) method.

### Example 3a: Preparing a Composite Material Comprising an Electride Compound Based on Mayenite and Comprising Aluminum

Three tablets (5, 10 and 20 weight-% Al) were prepared according to Reference Example 1.6 containing 0.475 g, 0.45 g and 0.40 g respectively of mayenite of Example 1 (Example 2 also possible) along with 0.025 g, 0.05 g and 0.10 g respectively of aluminum.

Employing said tablets, the respective three composite materials comprising an electride compound based on mayenite and comprising aluminum were then prepared according to the protocol described herein above in Example 3.

The EPR spectra of the respectively obtained three materials are shown in FIG. 6a. The electride materials generally exhibited resonances at a field of 335-345 mT which is in excellent agreement with literature data. To quantify the amount of free electrons in the samples, the spectra were integrated using the FWHM (full width at half maximum) method.

Furthermore, in view of said EPR spectra, the g values or g factors (from Landé gyromagnetic factor) were calculated. g values characterize the magnetic moment of any particle nucleus. The g value relates to the observed magnetic moment of a particle (in this case an electron) to its angular momentum quantum number. It is a proportionality constant. All of the obtained g values are in the range from 1.995 to 1.997. These values are characteristic for electrons inside the cages of the mayenite based electrides, confirming once more the successful preparation of the materials.

### Example 3b: Preparing a Composite Material Comprising an Electride Compound Based on Mayenite and Comprising Graphite

Two tablets (3 and 5 weight-% graphite) were prepared according to Reference Example 1.6, containing 0.485 g and 0.475 g respectively of mayenite of Example 1 (Example 2 also possible) along with 0.015 g and 0.025 g respectively of graphite.

Said tablets where then respectively placed in the recipient chamber on the copper electrode plate in the electrical arc furnace as described in Reference Example 1.
(i) The chamber was then evacuated for 30 seconds and then flooded with an Ar/H₂ atmosphere (5 volume-% H₂) three times, ultimately adjusting at absolute pressure of 0.7 bar.

The electric arc was then ignited at intensity level 5 and pointed at the tablet until a melt was formed.
(ii) Step (i) was then repeated.
(iii) The chamber was then opened, and the pellet turned around and placed again on the copper electrode plate in the electrical arc furnace as described in Reference Example 1.
(iv) Step (i) was then repeated.
(v) The chamber was opened and the black melting ball removed and crushed for analytical treatments as follows.

The electron concentration, according to the UV Vis spectra of the respectively obtained materials is:

1.3×10²¹ electrons per cubic centimetre (3 weight-% graphite)
0.5×10²¹ electrons per cubic centimetre (5 weight-% graphite)

Furthermore, the Kubelka-Munk transformed absorption spectra, obtained as described according to reference example 1.8, are shown in FIG. 6b, thus allowing to determine from the absorbance maxima (maxima corresponding to a certain colour of the material) from the measured reflectance spectrum. The resulting transformed spectra show a characteristic maxima corresponding to the colour of the electride, having a maxima between 2.5 and 3.00 eV which is typical for mayenite based electrides. Accordingly, the Kubelka-Munk transformed absorption spectra confirm the successful preparation of composite materials comprising an electride compound.

### Example 4: Preparing a Composite Material Comprising an Electride Compound Based on Mayenite and Comprising Silicon Carbide

A tablet was prepared according to Reference Example 1.6 containing 0.30 g mayenite of Example 1 (Example 2 also possible) and 0.20 g beta silicon carbide. The mayenite/aluminum tablet was placed in the recipient chamber on the copper electrode plate in the electrical arc furnace as described in Reference Example 1.1. The chamber was evacuated for 30 seconds and then flooded with an Ar/H₂ atmosphere (5 volume-% H₂) three times, ultimately adjusting an absolute pressure of 0.7 bar. The arc was then ignited at the intensity level 5 and directly pointed at the tablet for 15 seconds. This procedure was repeated twice. The black pellet was removed from the chamber after wards, crushed and investigated with XRD.

The XRD pattern of the respectively obtained composite material is shown in FIG. 7. The calcium aluminum oxides are characterized by the intensity ratios of the 211 (18.0° 2theta) and 420 (33.4° 2theta) reflections in their respective diffractograms. In calcium aluminum oxides with mayenite structures the intensity ratio of the 211/420 reflections is below one. In mayenite based electrides prepared in the electrical arc furnace, the intensity ratios are in the range of from above 1.3 to 2.1, depending on the concentration of unbound electrons in the material.

The compound prepared according to Example 4 showed an intensity ratio of the 211 reflection relative to the 420 reflection of 1.1.

### Example 5: Preparing a Composite Material Comprising an Electride Compound Based on Mayenite and Comprising Silicon Carbide (Spheres/Extrudates)

### 5.1 Impregnating Mayenite on a SiC Support (Extrudate)

Materials used:

2 g mayenite according to Example 1 (Example 2 also possible)
10 g deionized water
beta SiC extrudates (SICAT SARL, France) (5 mm*5 mm, about 100 mg per extrudate, pore volume 0.5 cm³/g; see FIG. 8)

2 g mayenite were suspended in 10 g of deionized water in PET beaker equipped with a Teflon coated magnetic stir bar. The mixture was magnetically stirred with 200 rpm to ensure dispersion of the mayenite powder. Ten Beta SiC extrudates were immersed in the suspension for 20 s and then transferred to a porcelain bowl. The bowl was placed in a muffle furnace (M110, Thermo Fisher Scientific Inc), heated to 200° C. and kept at this temperature for 24 h under a flow of nitrogen with a flow rate of 6 L/min.

### 5.2 Impregnating Mayenite on a SiC Support (Extrudate)

Materials used:

2 g mayenite according to Example 1 (Example 2 also possible)
8 g glycerine (Acros Chemicals, 99.5%)
beta SiC spheres (SICAT SARL, France) (6.5 mm, about 200 mg per sphere, pore volume 0.5 cm³/g, see FIG. 9)

65 beta SiC spheres were placed in a PET beaker containing 8 g of glycerine. The spheres were agitated manually for 30 min achieving a complete wetting with glycerine. The spheres were separated from the glycerine by placing them on a steel sieve (mesh size 0.1 mm). The impregnated spheres were transferred to another PET beaker containing finely ground mayenite powder. The beaker was rotated, thereby rolling the spheres in the mayenite. The maximum uptake was 400 mg for 65 spheres. The spheres were transferred to a porcelain bowl and placed in a muffle furnace (M110, Thermo Fisher Scientific Inc), heated to 500° C. with a heating rate of 5 K/min and kept at the temperature for 12 h, under flow of nitrogen with a flow rate of 6 L/min.

### 5.3 Preparing a Composite Material

An extrudate prepared according to 5.1 or a sphere prepared according to 5.2 was placed in the recipient chamber on the copper electrode plate in the electrical arc furnace as described in Reference Example 1.1. The recipient chamber was evacuated for 30 seconds and refilled with Ar/H₂ (5 volume-% H₂). This procedure was repeated twice, ultimately adjusting an absolute pressure of 0.7 bar. The extrudate/sphere body was treated with the electrical arc for 15 s at the intensity level 5. The recipient chamber was opened and the shaped body turned around. The chamber was sealed again, evacuated for 30 s and refilled with Ar/H₂ (5 volume-% H₂). This procedure was repeated twice adjusting a 0.7 bar Ar/H₂ pressure on the pressure gauge. The extrudate/sphere was treated two more times for 15 s at the intensity level 5. The chamber was opened, and the shaped body which showed the typical green color of an electride material was removed.

### Example 6: Preparing a Composite Material Comprising an Electride Compound Based on Mayenite and Comprising Silicon Carbide (Foam)

### 6.1 Impregnating Mayenite on a SiC Support (Foam)

Materials used:

2 g mayenite (from Example 1 (Example 2 also possible))
2.14 g deionized water
beta SiC foam (SICAT SARL, France, 30 mm diameter, 10 mm height, about 1.9 g, cell size 8-30 pores per inch (2.54 cm), see FIG. 10)

2 g finely ground mayenite powder and 2.14 g deionized water were placed in a mortar and ground to a paste manually. A beta SiC foam was than pressed into this paste evenly distributing the paste over the foam. The paste solidified within 5 min. The mayenite-loaded foam was then placed in a porcelain bowl and placed in a drying oven having a temperature of 120° C. The sample was kept at this temperature of 120° C. for 24 h. The dry beta SiC foam contained 0.43 g mayenite per g beta SiC.

### 6.2 Preparing Composite Material

An impregnated beta SiC foam prepared according to 6.1 was placed in the recipient chamber on the copper electrode plate in the electrical arc furnace as described in Reference Example 1.1. The recipient chamber was evacuated for 30 s and refilled with Ar/H₂ (5 volume-% H₂). This procedure was repeated twice, ultimately adjusting an absolute pressure of 0.7 bar. The foam was treated with the electrical arc for 15 s at the intensity level 5. This procedure was repeated twenty times, and after each treatment the chamber was evacuated and refilled with Ar/H₂ (5 volume-% H₂) with an absolute pressure of 0.7 bar. After the final treatment, the chamber was opened and the foam removed, which now had the typical blackish green color of an electride-type material. The material was crushed for XRD investigations.

The XRD pattern of the respectively obtained composite material is shown in FIG. 11.

### SHORT DESCRIPTION OF THE FIGURES

FIG. 1 shows a schematic drawing illustrating the general principle of the electric arc furnace described in Reference Example 1.1. In particular,
1 stands for the electric furnace recipient
2 stand for the tungsten electrode (cathode)
3 stands for the water-cooled copper anode
4 shows the distance between cathode and anode (about 20 mm)
5 shows the diameter of the anode (101 mm)
6 shows the height of tungsten electrode (63 mm)
7 shows the height of the housing (158 mm)
8 stands for the housing

FIG. 2 shows a schematic drawing illustrating the general principle of the electric arc furnace described in Reference Example 1.1. In particular,
1 stands for the electric furnace recipient
2 shows the connection to a vacuum pump
3 shows the connection to a gas reservoir (e.g. for Ar or for Ar/H₂)
4 shows an air vent

FIG. 3 shows the linear correlation of the apparatus settings (intensity levels) and the corresponding electric power for two different gas atmospheres in the electric arc furnace.

FIG. 4 shows the XRD pattern of the oxidic compound prepared according to Example 1.

FIG. 5 shows the XRD pattern of the composite material prepared according to Example 3.

FIG. 6 shows the EPR spectrum of the composite material prepared according to Example 3.

FIG. 6a shows the EPR spectra of the composite materials prepared according to Example 3a, showing the g values.

FIG. 6b shows the Kubelka-Munk transformed absorption spectra of the composite material comprising an electride compound based on mayenite and comprising graphite, prepared according to Example 3b.

FIG. 7 shows the XRD pattern of the composite material prepared according to Example 4.

FIG. 8 shows the beta SiC extrudates used according to Example 5.1

FIG. 9 shows a beta SiC sphere used according to Example 5.2

FIG. 10 shows the beta SiC foam used according to Example 6.1

FIG. 11 shows the XRD pattern of the composite material prepared according to Example 6.2.

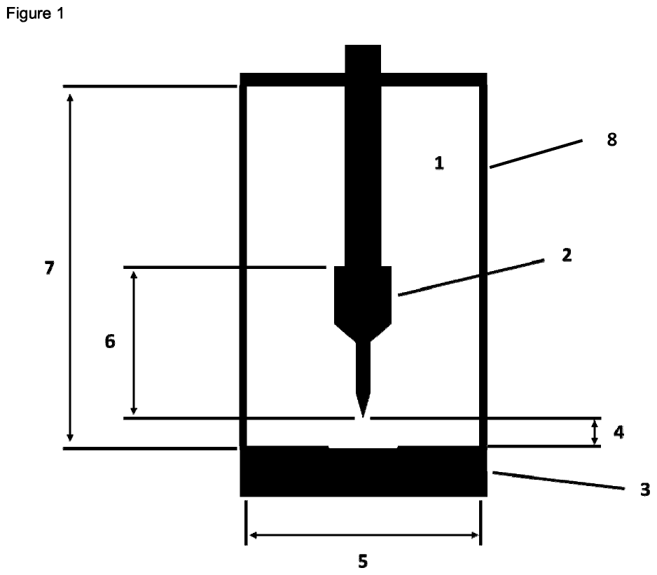

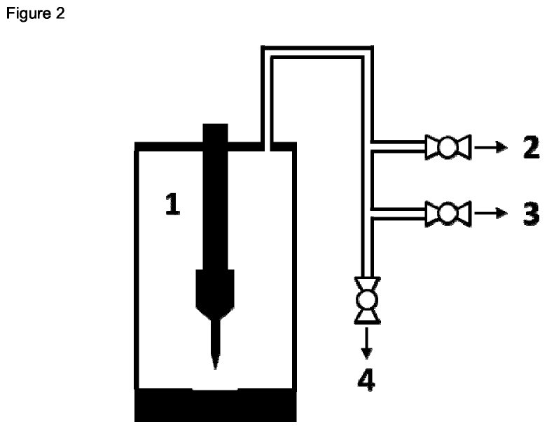

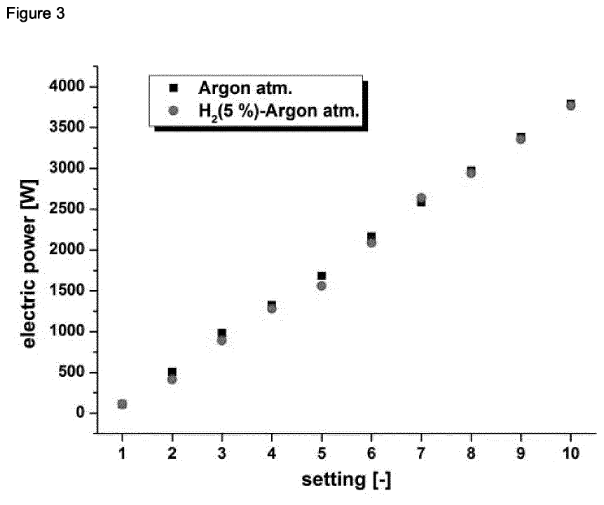

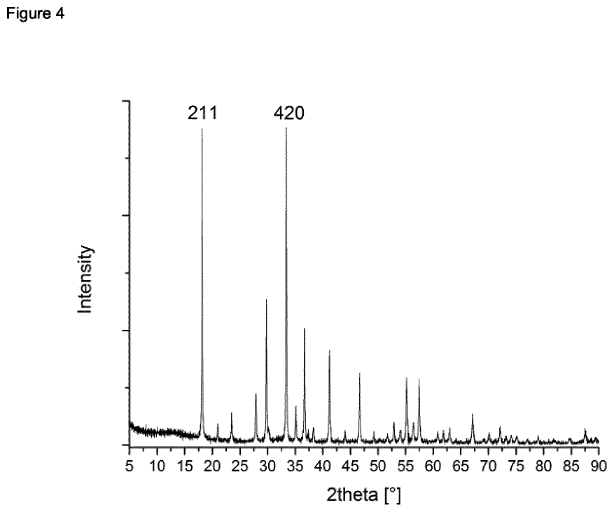

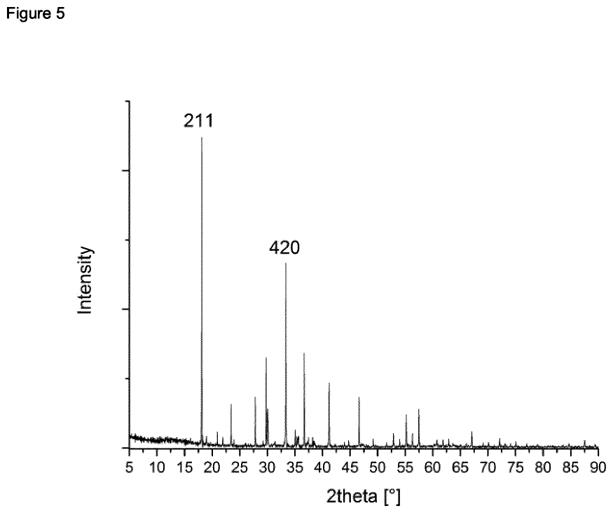

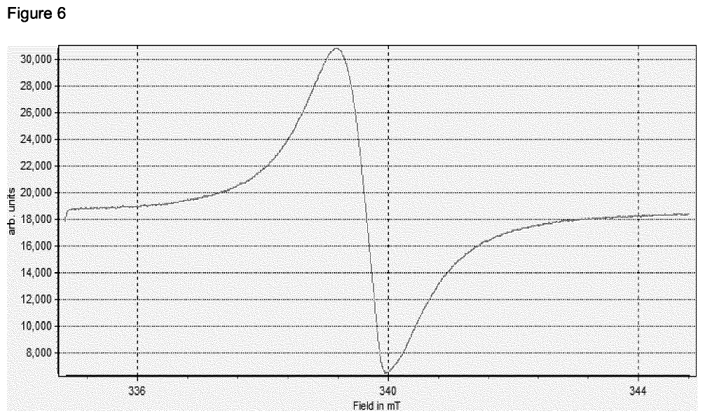

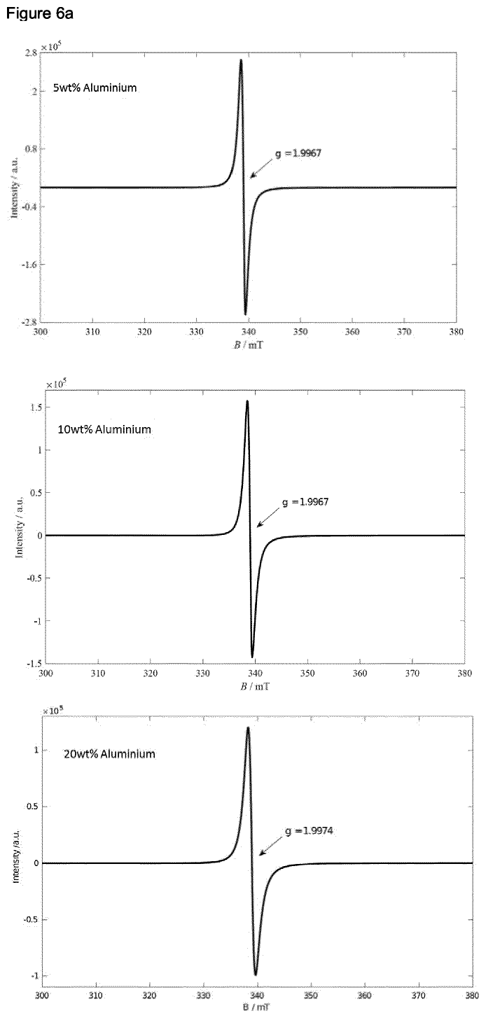

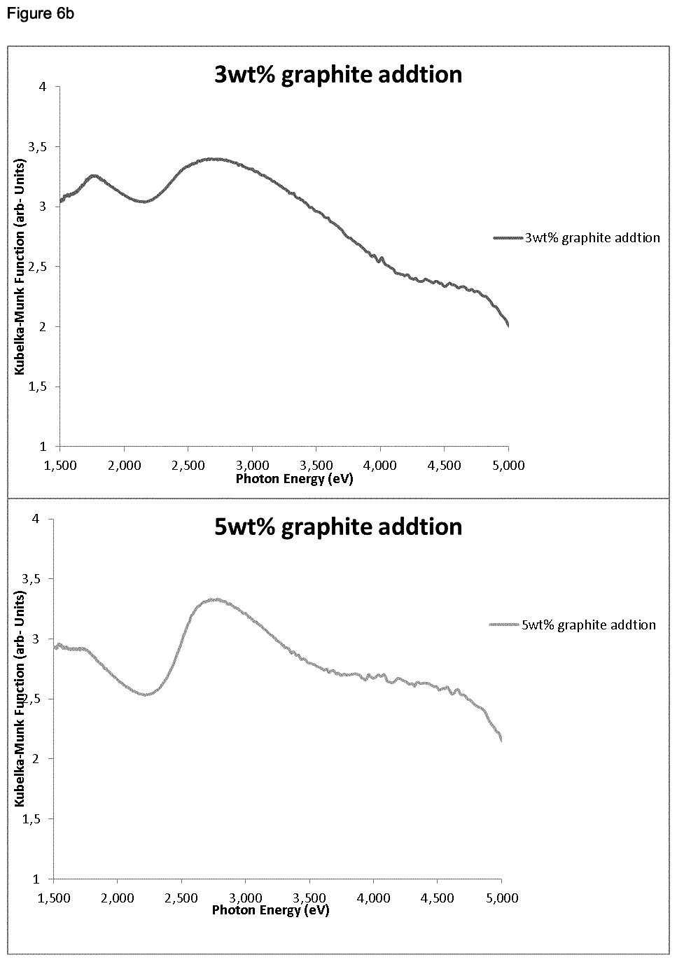

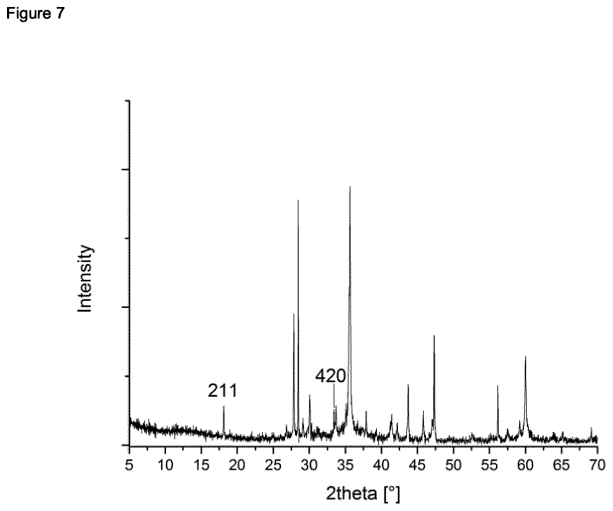

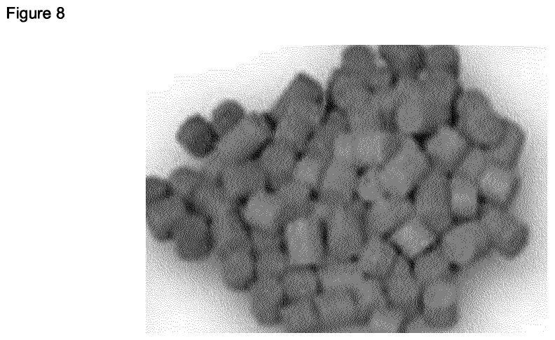

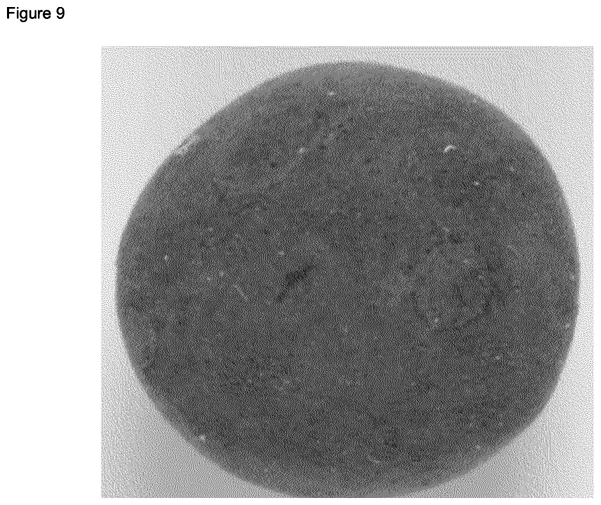

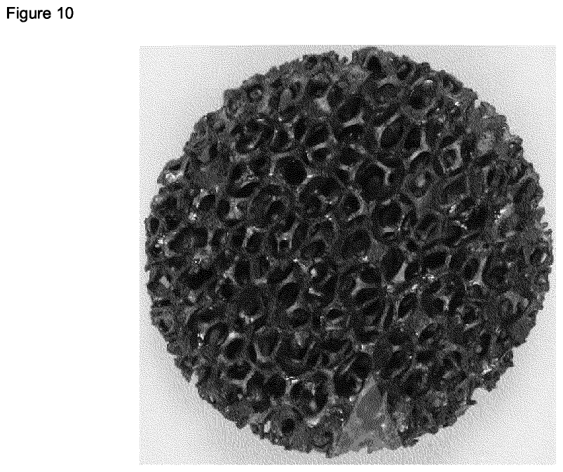

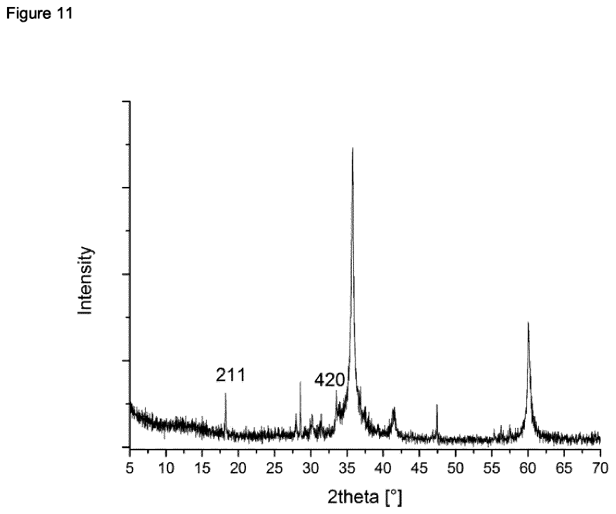

### CITED PRIOR ART

Y. Nishio, K. Nomura, M. Miyakawa, K. Hayashi, H. Yanagi, T. Kamiya, M. Hirano and H. Hosono, “Fabrication and transport properties of 12CaO.7Al2O3 (C12A7) electride nanowire,” Phys. Stat. Sol. (A) (Physica Status Solidi (A)), 2008, pp 2047-2051
J. L. Dye, “Electrons as Anions”, Science, 2003, pp 607-608
J. L. Dye, “Electrides: early examples of quantum confinement”, Acc Chem Res, 2009, pp 1564-1572
US 2006/0151311 A1
US 2009/0224214 A1
US 2015/0217278 A1
E. S. Grew et al., American Mineralogist, vol. 98, 2013, pp 785-211

1-20. (canceled)

21. A process for preparing a composite material comprising an electride compound and an additive, said process comprising
(i) providing a composition comprising the additive and a precursor compound of the electride compound, wherein the precursor compound comprises an oxidic compound of the garnet group, and wherein the additive has a boiling temperature which is higher than the melting point of the precursor compound;
(ii) heating the composition provided in (i) under plasma forming conditions in a gas atmosphere to a temperature above the Hüttig temperature of the precursor compound and below the boiling temperature of the additive, obtaining the composite material.

22. The process of claim 21, wherein according to (ii), heating the composition under plasma forming conditions comprises heating the composition in an electric arc, wherein according to (ii), the composition provided in (i) is heated to a temperature above the Tamman temperature of the precursor compound and below the boiling temperature of the additive, preferably Wherein according to (ii), the composition provided in (i) is heated to a temperature above the melting temperature of the precursor compound and below the boiling temperature of the additive.

23. The process of claim 21, wherein the oxidic compound of the garnet group according to (i) comprises aluminum and/or calcium.

24. The process of claim 21, wherein at least 90 weight-% of the precursor compound consist of an oxidic compound of the garnet group.

25. The process of claim 21, comprising
(i) providing a composition comprising the additive and a precursor compound of the electride compound, Wherein the precursor compound comprises an oxidic compound of the garnet group, and wherein the additive has a boiling temperature which is higher than the melting point of the precursor compound;
(ii) heating the composition provided in (i) in an electric arc in a gas atmosphere to a temperature above the Hüttig temperature of the precursor compound and below the boding temperature of the additive, obtaining the electride compound.

26. The process of claim 21, wherein providing the composition according to (i) comprises
(i.1) providing the precursor compound and providing the additive;
(i.2) preparing the composition comprising the additive and the precursor compound provided in (i.1);
wherein in the composition provided in (i), the weight ratio of the precursor compound relative to the additive is in the range of from 0.01:1 to 1000:1
(i.1.1).

27. The process of claim 26, wherein the source of calcium is one or more of a calcium oxide, a calcium hydroxide, a hydrated calcium oxide, and a calcium carbonate, and the source of aluminum is one or more of an aluminum hydroxide including one or more of gibbsite, hydrargillite, bayerite, doyleite, nordstrandite, and gel-like amorphous aluminum hydroxide, an aluminum oxyhydroxide including one or more of pseudo-boehmite, boehmite, diaspor, and akdalaite, and an aluminum oxide including one or more of gamma aluminum oxide, chi aluminum oxide, delta aluminum oxide, eta aluminum oxide, rho aluminum oxide and kappa aluminum oxide.

28. The process of claim 26, wherein according to (i.1.3), the mixture is calcined in a gas atmosphere, wherein the gas atmosphere comprises oxygen.

29. The process of claim 26, wherein preparing the composition according to (i.2) comprises mixing the additive with the precursor compound.

30. The process of claim 21, wherein the additive has a boiling temperature which is at least 20° C. higher than the melting temperature of the precursor compound.

31. The process of claim 21, wherein the additive comprises a metal compound, a semi-metal compound or a non-metal compound which is an oxygen getter material reducing the oxygen partial pressure during heating under plasma conditions according to (ii).

32. The process of claim 21, wherein the additive is in the form of a molding.

33. The process of claim 21, wherein the heating according to (ii) is carried out in an electric arc furnace which comprises a first electrode and a second electrode between which the electric arc is formed, wherein on the second electrode, the composition to be heated is positioned, and wherein during heating according to (ii), the electrical power of the light arc between the first electrode and the second electrode is in the range of from 100 to 4000 W.

34. The process of claim 21, wherein according to (ii), the composition is heated under plasma forming conditions for a period of time in the range of from 1 to 350 s.

35. The process of claim 21, wherein heating the composition provided in (i) under plasma forming conditions according to (ii) is carried out under oxygen (O₂) removal conditions, wherein the oxygen removal conditions comprise physical oxygen removal conditions and/or chemical oxygen removal conditions.

36. The process of claim 35, wherein the chemical oxygen removal conditions comprise a gas atmosphere according to (ii) which comprises an oxygen reducing gas, and wherein the gas atmosphere according to (ii) comprises a gas which is ionizable under the plasma forming conditions according to (ii).

37. The process of claim 35, wherein the physical oxygen removal conditions comprise
(ii.1) heating the composition provided in (i) in the gas atmosphere under plasma forming conditions for a period of time delta₁t, wherein the gas atmosphere comprises a gas which is ionizable under the plasma forming;
(ii.2) at least partially removing the gas atmosphere after the period of time delta₁t and providing a fresh gas atmosphere comprising a gas which is ionizable under the plasma forming conditions;
(ii.3) further heating of the composition obtained from (ii.2) in the fresh gas atmosphere under plasma forming conditions for a period of time delta₂t

38. A composite material comprising an electride compound and an additive, obtained by the process according to claim 21.

39. A composite material comprising an electride compound and an additive, wherein the additive comprises an element of group IIIA or group IVA of the periodic table; wherein the electride compound is obtained from an oxidic compound of the garnet group as defined in claim 23 by heating under plasma forming conditions; wherein the composite material exhibits one or more of
a BET specific surface area in the range of from 2 to 1000 m²/g;
an XRD pattern comprising a 211 reflection and a 420 reflection;
an EPR spectrum comprising resonances in the range of from 335 to 345 mT.

40. Use of a composite material according to claim 38 as a catalyst or a catalyst component.
